(19) United States
(12) Patent Application Publication
(10) Pub. No.: US 2012/0069797 A1
(43) Pub. Date: Mar. 22, 2012

(54) METHOD FOR A COMMUNICATION NODE WITH A PLURALITY OF COMMUNICATION INTERFACES TO NOTIFY DYNAMIC PATH SETUP AND ASSOCIATES APPARATUS THEREOF

(75) Inventors: Chun Keong Benjamin Lim, Singapore (SG); Chan Wah Ng, Singapore (SG); Keigo Aso, Kanagawa (JP); Shinkichi Ikeda, Kanagawa (JP)

(73) Assignee: PANASONIC CORPORATION, Osaka (JP)

(21) Appl. No.: 13/203,354

(22) PCT Filed: Mar. 1, 2010
(86) PCT No.: PCT/JP2010/001372

§ 371 Date: Nov. 4, 2011

(30) Foreign Application Priority Data
Feb. 27, 2009 (JP) 2009-046772
Dec. 25, 2009 (JP) 2009-294877

(51) Int. Cl. H04W 88/06

(52) U.S. Cl. 370/328

(57) ABSTRACT

A User Equipment (UE) that is simultaneously connected (via a 3G connection and a non-3G connection) to a Packet Data Network Gateway (P-GW) can direct how traffic flows would be routed from the P-GW to the UE. Typically, the P-GW would setup the 3G communication path to the UE when it receives a downlink data packet directed to the UE's 3G path. If the P-GW uses such logic for setting a communication path to the UE without knowing the user's actual intention, this might result in the case where the user would experience some service degradation for ongoing session. In addition, it is possible that the packets filters for a first UE interface are not utilized due to the erroneous setting of the packets filters for a second UE interface. To resolve this issue, the UE would indicate to the P-GW of the user's intention for communication path setup with the benefit of conserving the UE's battery.

### TECHNICAL FIELD

This invention relates to the field of telecommunications in a packet-switched data communications network system. More particularly, it relates to a first communication node notifying a second communication node to dynamically configure a new communication path from the second communication node to the first communication node.

### BACKGROUND ART

In Third Generation Partnership Project (3GPP), the Long Term Evolution (LTE) program is developing a new system, termed the Evolved Packet System (EPS), that provides improved spectral efficiency, reduced latency and better utilization of radio resources. With the EPS, users can experience faster data rate and richer application and services at less cost. In order to get connectivity to the EPS, a user has to obtain a User Equipment (UE) which has to be LTE compliant. In recent market trends, the UE is deemed to support multiple different radio technologies. For example, all mobile phones have at least a cellular radio interface to access the mobile cellular network. In addition, an increasing number of these mobile phones also have an IEEE 802.11 radio interface that can access a Wireless Local Area network (WLAN).

FIG. 1 illustrates a system described in the Third Generation Partnership Program (3GPP). In this system, UE 0100 gains connectivity to EPS 010 via both its cellular radio interface (IF 01000) and WLAN radio interface (IF 01001). IF01001 could be, but not limited to, WiMAX interface or cdma2000 HRPD (High Rate Packet Data) interface. EPC 10 typically comprises an Evolved NodeB (eNB 0101), a Mobility Management Entity (MME 0102), a Serving Gateway (S-GW 0103), a Packet Data Network Gateway (P-GW 0104), an Evolved Packet Data Gateway (ePDG 0105) and a Policy Server (PCRF 0106). In some systems, EPS 010 could comprise one or many of the entities described in EPC 010.

The eNB 0101 handles the radio resource management and admission control for UE 0100. In addition, eNB 0101 is also responsible for header compression, ciphering and reliable delivery of packets. The MME 0102 is responsible for the idle mode mobility signalling for UE 0100. This includes tracking and paging for UE 0100 when UE 0100 is connected to EPS 010. Furthermore, MME 0102 is involved in the bearer activation/deactivation process for UE 0100. For this technology, a bearer is an information transmission path of defined capacity, delay and bit error rate.

The S-GW 0103 assists in the routing user data packets. In addition, the S-GW 0103 also acting as a mobility anchor point for the user plane during handovers between different access systems. The P-GW 0104 provides connectivity to UE 0100 to external packet data networks. Also, P-GW 0104 has the ability to route user data packets based on filtering rules (i.e. routing filters or packet filters) described by UE 0100. For this system, P-GW 0104 uses data path 01040 to route data packets between EPS 010 and Global Communications Network 011. The PCRF 0106 is the policy and charging control element for UE 0100.

Finally, in this system, a Correspondent Node (CN 0110) is an entity that is involved in an end-to-end data communication with UE 0100. As an example, the data traffic between UE 0100 and CN 0110 is a video conference call flow that comprises video packet stream and voice packet stream. CN 0110 uses data path 01110 for communication to the Global Communications Network 011.

For UE 0100 to be able to send or receive data packets using EPS 010, a transmission path needs to be established between UE 0100 and EPS 010. For this system, IF 01000 is a cellular radio interface that establishes a radio link with eNB 0101. Whenever UE 0100 is connected to EPS 010, a default bearer would always be present for UE 0100. This default bearer represents a dedicated transmission path between EPS 010 and UE 0100.

Typically, UE 0100 would not be transmitting or receiving data packets constantly. At intervals when IF 01000 is not sending or receiving data packets, in order to conserve the battery in UE 0100, IF 01000 would enter an idle state. In this idle state, IF 01000 would reduce the drain of UE 0100 battery level by turning off the transmitter function of IF 01000. When UE 0100 is in idle state, the default bearer would not be physically present as the EPS 010 does not have knowledge of where UE 0100 may move while in idle state. However, to allow for quick path setup, whenever EPS 010 needs to send data packets to UE 0100, MME 0102 would remember some information of the default bearers that allows MME 0102 to reduce the amount of time taken to re-establish the default bearer. The information MME 0102 remembers may be, but not limited to, the identifier of the transmission path or the security code used to encrypt messages for the transmission path. If EPS 010 needs to forward a data packet to UE 0100 while IF 01000 is in idle state, MME 0102 would page for UE 0100 to wake up the transmitter function of IF 01000.

FIG. 2 shows a message sequence diagram that explains how data packets could be routed to UE 0100 while UE 0100 is in idle state. Initially, UE 0100 is in idle state (S0200). This implies that IF 01000 transmitter function is turned off. When P-GW 0104 has a data packet that needs to be sent to UE 0100, P-GW 0104 transmits a downlink data trigger message (S0201) to signal MME 0102 to find UE 0100 in EPS 010. In order to determine the location of UE 0100 in EPS 010, MME 0102 pages for UE 0100 within EPS 010 (S0202). Once UE 0100 receives the paging message, UE 0100 turns on the transmitter function of IF 01000 (S0203). This would allow UE 0100 to be connected to EPS 010 for data reception.

UE 0100 proceeds to send a service request message (S0204) to let MME 0102 know that UE 0100 has received the paging message. With the knowledge of where UE 0100 is within EPS 010, MME 0102 informs P-GW 0104 via a paging success message (S0205) that UE 0100 has been located. Concurrently, MME 0102 responds to the service request message by informing UE 0100 that the default bearer has been re-established (S0206). With UE 0100 located within EPS 010, P-GW 0104 begins to route the data packet over the default bearer to UE 0100 (S0207).

UE 0100 knows that the default bearer is not able to support the incoming data packet flow. The reason is that the Quality of Service (QoS) level does not meet the requirement for the incoming data packet flow. Hence, UE 0100 sends a modify bearer message to MME 0102 to request for another bearer with the appropriate QoS to support the incoming data packet flow (S0208). Also, UE 0100 includes a Traffic Flow Template (TFT) that allows P-GW 0104 to understand how UE 0100 wants the incoming data packet flow to be routed to UE 0100. MME 0102 forwards this bearer request message along with the TFT from UE 0100 to P-GW 0104 for approval (S0209). The TFT indicates an incoming data packet identified by the packet filter and a bearer which the incoming data packet is routed to.

Typically, P-GW 0104 would consult with PCRF 0106 to determine if the UE 0100 policy allows for such QoS level request. If the QoS level is approved, P-GW 0104 would notify MME 0102 that a secondary bearer with the desired QoS level can be created to UE 0100 (S0210). The MME 0102 informs UE 0100 that the request was granted and a secondary bearer with the desired QoS has been made available for UE 0100 (S0211). For this prior art, as the TFT from UE 0100 indicates to P-GW 0104 that the incoming data packet flow is to be routed via the secondary bearer, P-GW 0104 proceeds to route data packets to UE 0100 via the secondary bearer (S0212).

Referring back to FIG. 1, UE 0100 could use IF 01001 to connect to EPS 010 to achieve simultaneous connectivity. In this system, IF 01001 is a WLAN radio. For IF 01001 to gain connectivity to EPS 010, IF 01001 establishes a transmission path via a radio link with ePDG 0105. The ePDG 0105 is an entity that acts as a gateway for access systems that are not native to the LTE system. Similarly, for UE 0100 to receive packets on IF 01001, ePDG 0105 has a data transmission path to P-GW 0104 to allow P-GW 0104 to send data packets to IF 01001 via ePDG 0105.

A mobility protocol that could be used to allow UE 0100 to attain simultaneous connectivity to EPS 010 is described in Non-Patent Document 1. In this prior art, a Binding Identifier (BID) allows UE 0100 to uniquely identify both IF 01000 connection and IF 01001 connection to P-GW 0104. The BID is carried in the Binding Update (BU) message from UE 0100 to P-GW 0104. The BU message serves as a periodic update by UE 0100 to P-GW 0104 to let P-GW 0104 know that UE 0100 is still connected. Since, the BU message has to be sent at least every 7 minutes, it can be deemed that IF 01001 would never enter an idle state for too long. Hence, such idle state methodology does not apply when UE 0100 connects to EPS 010 via ePDG 0105.

When P-GW 0104 understands there are multiple data paths to UE 0100, P-GW 0104 could then begin to selectively route data packet flows accordingly to UE 0100 via the multiple data paths. A simple method is for UE 0100 to provide descriptions for each data packet flows to P-GW 0104 which, permits P-GW 0104 to understand which data packet flow traverses which data path to UE 0100. These flow descriptions (a routing rule containing both a routing filter and a forwarding destination for the IP flows identified by the routing filter) are also carried by the BU message. This method of selective routing is further described in Non-Patent Document 2, Non-Patent Document 3 and Patent Document 1.

### CITATION LIST

### Patent Literature

[PTL 1] R-J Titmuss, C-A-M Lebre and J-L Taylor, “Mobile Communications Network”, WO Patent Application Publication Number 2000/042755A1, Jul. 20, 2000.

[PTL 2] A. Damle, S. Faccin and Z. Fan, “Multiple packet data network support over trusted access”, US Patent Application Publication Number 2009/0022126A1, Jan. 22, 2009.

[PTL 3] R. Ludwig, N-S. Lundin and P. Johnsen, “Method and system for dynamically configuring a traffic flow template”, WO Patent Application Publication Number 2007/129199A2, Nov. 15, 2007.

[PTL 4] I. Widegren, G. Fodor, B. Williams and J. Oyama, “Application influenced policy”, US Patent Application Publication Number 2002/0036983A1, Mar. 28, 2002.

[PTL 5] Gorg. C-P, Pangboonyanon. V, Pittmann. F, Toseef. U and Udugama. A, “Method for network controlled Mobile IP-based flow management”, European Patent Application Publication Number 2081352 A1, Jul. 22, 2009.

### Non Patent Literature

[NPL 1] R. Wakikawa, V. Devarapalli, T. Ernst and K. Nagami, “Multiple Care-of Addresses Registration”, draft-ietf-monami6-multiplecoa-11, Jan. 13, 2009.

[NPL 2] H. Soliman, N. Montavont, N. Fikouras and K. Kuladinithi, “Flow Bindings in Mobile IPv6 and Nemo Basic Support”, draft-soliman-monami6-flow-binding-05, Nov. 19, 2007.

[NPL 3] C. Larsson, H. Levkowetz, H. Mahkonen and T. Kauppinen, “A Filter Rule Mechanism for Multi-access Mobile IPv6”, draft-larsson-monami6-filter-rules-02, Mar. 5, 2007.

[NPL 4] G. Tsirtsis, G. Giarreta, H. Soliman and N. Montavont, “Traffic Selectors for Flow Bindings”, draft-ietf-mext-binary-ts-02, Dec. 16, 2009.

[NPL 5] 3GPP TS 24.301: “Non-Access-Stratum (NAS) protocol for Evolved Packet System (EPS); Stage 3”.

### SUMMARY OF INVENTION

### Technical Problem

As seen in FIG. 2, P-GW 0104 would only be triggered to look for IF 01000 of an idle state UE 0100 within EPS 010 when P-GW 0104 has pending data packet to be sent to UE 01(X). This logic at P-GW 0104 could lead to a problem where the user would suffer a degradation of service within EPS 010 due to the delay in receiving data packets. The issues lie in that P-GW 0104 does not know the intention of the user on when the bearer to IF 01000 should be established. This uncertainty brings about a degradation of service for the user and also additional signalling to notify P-GW 0104 on how to selectively route data packets to the multiple paths of UE 0100.

FIG. 3 describes a signalling diagram of the problem that a UE faced with simultaneous connectivity to the EPS. For this system, IF 01000 for UE 0100 is currently in idle state (S0200). UE 0100 has another connection (IF 01001) to P-GW 0104 via ePDG 0105. P-GW 0104 has a data packet to be sent to UE 0100. Since P-GW 0104 knows that UE 0100 could be reachable via IF 01001, P-GW 0104 routes the data packet to IF 01001 (S0301). The data packet comprises a voice data packet and a video data packet. When UE 0100 receives the data packet, the user of UE 0100 decides to split the data packet flow into two streams. The voice data packet (as there are some QoS requirements) would be routed to IF 01000 as the connection supports QoS routing. The video data packet (which does not have QoS requirements) would be routed to IF 01001.

With the decision made, UE 0100 sends a filter update message to P-GW 0104 to convey the intention of the user for selective routing (S0302). P-GW 0104 notes the routing filters described by UE 0100 and acts accordingly when the next data packet arrives. In this case, P-GW 0104 routes the video data packet to IF 01001 with accordance to the user's intention (S0303). However, since IF 01000 is in idle state, P-GW 0104 would only trigger the paging for UE 0100 while routing the video data packet to IF 01001. The steps of S0201 to S0207 in FIG. 3 are as per explained previously and would hence be omitted here.

Referring to FIG. 3, it is clear that due to the uncertainty of P-GW 0104 which results in the waiting for a subsequent data packet before paging for UE 0100, the user of UE 0100 suffers a delay in receiving the voice data packet as compared to the video data packet. To illustrate this with an example, imagine the data packet in S0301 is a video conference call session. Subsequently, when the video data packet and voice data packet arrives at a significant amount of time difference at UE 0100, the user would see an image of the caller moving the mouth but nothing can be heard until later in time. This translates to poor user experience as the user expects a certain service level to be guaranteed.

Moreover, if the default bearer is unable to fully support the QoS requirement for the voice data packet, the user would have to request for another bearer with a suitable QoS level for the voice data packet. The steps of S0208 to S0212 in FIG. 3 are as per explained previously and would hence be omitted from this description. To make matters worse, the packet filters in the TFT described in S0208 would be identical to the routing filter in the filtering rule described in S0302 (e.g. voice data packet to IF 01000). This implies UE 0100 to perform additional signalling to re-specify the routing filter at P-GW 0104.

Patent Document 2 explains how a proxy entity could assist a UE to notify the P-GW of the routing filters for the UE. In addition, the proxy entity could let P-GW know that the UE has simultaneous connectivity to the P-GW. Although, this prior art provides an indication to the P-GW about the UE's intention, the prior art does not describe further that the indication could be used to allow P-GW to know if a new QoS path to the UE's other interfaces needs to be setup. Hence, this prior art cannot fully solve the problem of this invention.

Patent Document 3 describes about an entity with a little bit similar function as the P-GW as described in this invention. The P-GW uses the information of an uplink packet from the UE to self-generate a routing filter for the downlink packets matching the uplink flow. This implies that the UE need not send any filter message to the P-GW thereby, solving the additional signalling problem described in this invention.

Patent Document 4 tells about a UE sending a request to a gateway node (which could be deemed as a P-GW in our invention). The P-GW will query a policy to determine if the UE is allowed to establish a path to the P-GW. This means that the prior art solves the problem of establishing a new QoS path for UE described in this invention. However, the prior art does not state whether this request message is sent individually for each interface of UE or concatenated into a single request message. This implies that the request message for a UE with multiple interfaces may have to be repeated multiple times which would incur the problem of additional signalling performed by the UE.

Patent Document 5 discloses a means for network controlled flow mobility, by having a network entity (Flow Management Enforcement Function) set routing filters at a home agent for the mobile node. It is cited that network-based control has the advantage to make faster and reliable flow management decisions rather than the mobile node as the network knows the network load that a mobile node is connected to and can direct flows to reduce network congestion. This implies that the UE need not send any filter message to the P-GW, thereby solving the additional signalling problem described in this invention.

In addition, there exists another problem for the scenario shown in FIG. 1. It can be envisioned that entities (i.e. UE, P-GW) that implement both 3GPP access (i.e. cellular) and non-3GPP access (i.e. WLAN) would have the respective protocol stacks of the various accesses to be independent of each other. In most 3GPP implementation, the non-3GPP access protocol stack would be implemented above the 3GPP access protocol stack. For example, for traffic routing in the P-GW, the non-3GPP access stack (known as IPv6 stack) would use routing filters as described in Non-patent Document 4. On the other hand, for traffic routing in the P-GW, the 3GPP access stack (known as Non Access Stratum stack) would use traffic flow templates (TFT) as described in Non-patent Document 5. As seen in the format described in Non-patent Document 4 and Non-patent Document 5, it can be realized that both formats are a duplicate of each other. For example, the purpose of “Source Address” field in Non-patent Document 4 is similar to the “IPv6 remote address type” in Non-patent Document 5. In the event if both protocol stacks are independent of each other, rules of traffic filtering would need to be duplicated at both stacks in order for traffic routing to be enforced correctly. Failure to ensure the duplication might result in the case where the routing for a traffic is not enforced in accordance to the network operator preference.

For example, referring to FIG. 1, it is assumed that the communication path from P-GW 0104 to IF 01001 serves as the default path for UE 0100. Currently, no routing filter is set between P-GW 0104 and UE 0100. In addition, the communication path from P-GW 0104 to IF 01000 has TFTs negotiated with P-GW 0104 for a voice communication flow. The TFTs convey the network operator's preference on how the voice communication flow would be routed in order to guarantee the quality of service to the user. When P-GW 0104 receives the voice communication flow, the flow would be passed to the non-3GPP access protocol stack. As there is no routing filter, the voice communication flow would be routed to the default path as described in Non-patent Document 2. This implies that the TFTs created for the 3GPP access are not utilized and thus the quality of service is not met. This would lead to bad user experience, such as a degradation of a voice communication in which the network operator is supposed to guarantee.

It is thus an object of the present invention to overcome or at least substantially ameliorate the afore-mentioned disadvantages and shortcomings of the prior art. Specifically, it is an object of the present invention to provide a method and apparatus for dynamically configuring a new communication path.

### Solution to Problem

Accordingly, it is provided in this invention an apparatus for notifying intention for dynamic path setup comprising a decision unit that determines the requirement for a new communication path to be setup; an informing unit that notifies the intention of dynamically configuring a new communication path; and a reception unit that receives the indication that the new communication path has been setup as requested.

In another preferred embodiment of this invention, an apparatus is provided for notifying intention for dynamic path setup further comprising a generation unit that dynamically maps one set of filtering rules (i.e. routing filters or packet filters) for one communication path to other communication path.

Furthermore, it is provided in this invention an apparatus which serves as a user terminal, said user terminal having a first interface for connecting to a network via a first access system and a second interface for connecting said network via a second access system, comprising:

a determining unit that determines, upon receiving a packet of a packet flow on said first interface, whether or not to receive said packet flow by using both of said first and second interfaces; and

a transmitting unit that transmits a message from either said first or second interface to a particular node in said network in case of determining to receive said packet flow by using both of said first and second interfaces, said message including intention to receive said packet flow by using both of said first and second interfaces and information needed for said packet flow to traverse via said second access system.

Furthermore, it is provided in this invention a network node deployed in a network where a user terminal connects, said user terminal having a first interface for connecting to said network via a first access system and a second interface for connecting said network via a second access system, comprising:

a forwarding unit that forwards a packet addressed to said user terminal via said first or second access system; and

a forwarding control unit that, when receiving from said user terminal a message including intention to receive said packet flow by using both of said first and second interfaces and information needed for said packet flow to traverse via said second access system, controls said forwarding unit to forward said packet flow based on said information needed for said packet flow to traverse via said second access system.

### ADVANTAGEOUS EFFECTS OF INVENTION

This invention has the advantage of dynamically configuring a new communication path, saving the battery power and reducing a number of message exchanges and delay.

### BRIEF DESCRIPTION OF DRAWINGS

FIG. 1 is a diagram illustrating a network topology for a system described in the Third Generation Partnership Program (3GPP) according to a prior art and a preferred embodiment of the invention.

FIG. 2 is a diagram illustrating a message sequence on how data packets could be routed to a user equipment while in idle state according to a prior art.

FIG. 3 is a diagram illustrating a message sequence describing the problem that a user equipment faces with simultaneous connectivity to the evolved packet system according to a prior art.

FIG. 4 is a diagram illustrating a flow chart on how the decision for notifying a packet data network gateway of a user's intention is made by the user equipment according to a preferred embodiment of the present invention.

FIG. 5 is a diagram illustrating the format of a filter update message according to a preferred embodiment of the invention.

FIG. 6 is a diagram illustrating a flow chart on how a packet data network gateway processes the filter update message according to a preferred embodiment of this invention.

FIG. 7 is a diagram illustrating the format of a path notification message according to a preferred embodiment of the invention.

FIG. 8 is a diagram illustrating a flow chart on how a user equipment processes the path notification message according to a preferred embodiment of this invention.

FIG. 9 is a diagram illustrating a message sequence providing a summary of the actions taken by the various entities according to a preferred embodiment of this invention.

FIG. 10 is a diagram illustrating the format of a filter update message according to another preferred embodiment of the invention.

FIG. 11 is a diagram illustrating the functional architecture of a preferred apparatus according to this invention.

FIG. 12 is a diagram illustrating the functional architecture of another preferred apparatus according to this invention.

FIG. 13 is a diagram illustrating a flow chart on another decision process taken by a user equipment for notifying a packet data network gateway according to a preferred embodiment of the present invention.

FIG. 14 is a diagram illustrating the format of a filter update message according to another preferred embodiment of the invention.

FIG. 15 is a diagram illustrating a first flow chart on how the decision is taken by a UE for notifying P-GW of routing filter when the policy conflict occurs according to one preferred embodiment of this invention.

FIG. 16 is a diagram illustrating a second flow chart on how the decision is taken by a UE for notifying P-GW of routing filter when the policy conflict occurs according to one preferred embodiment of this invention.

FIG. 17 is a diagram illustrating a third flow chart on how the decision is taken by a UE for notifying P-GW of routing filter when the policy conflict occurs according to one preferred embodiment of this invention.

FIG. 18 is a diagram illustrating a fourth flow chart on how the decision is taken by a path setup decision engine for notifying P-GW of routing filter when the policy conflict occurs according to one preferred embodiment of this invention.

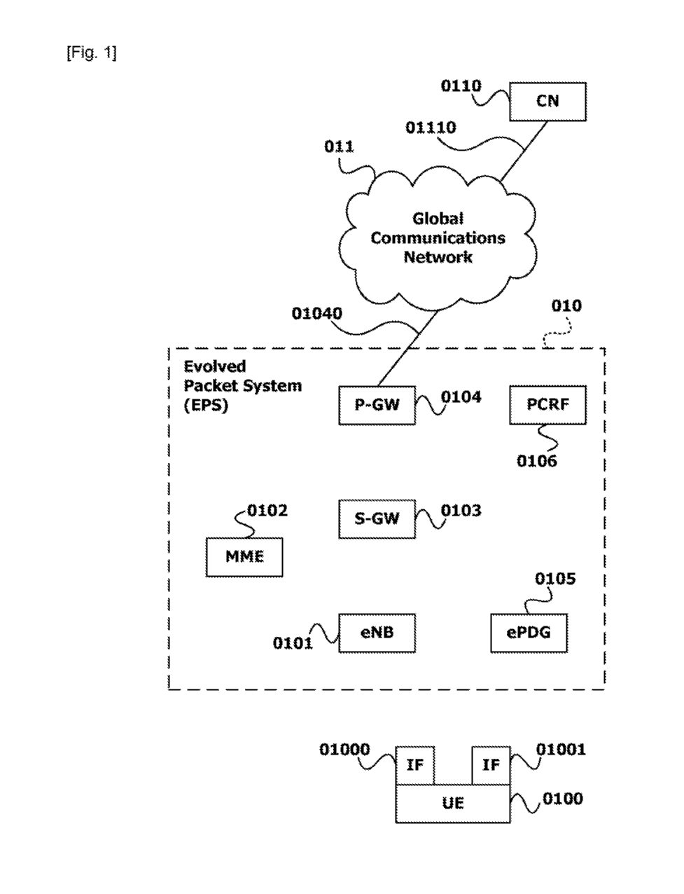

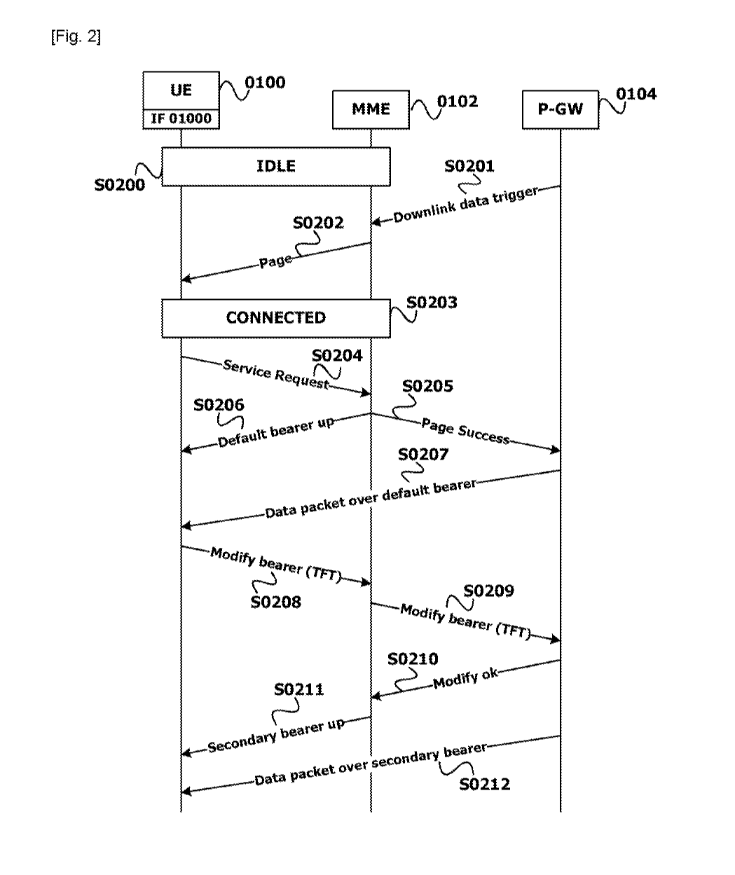

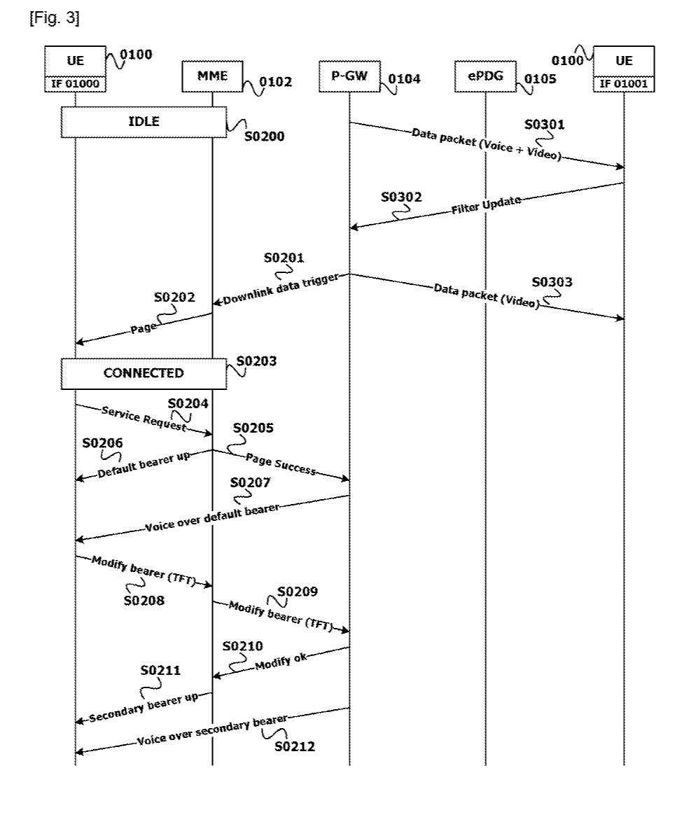

### DESCRIPTION OF EMBODIMENTS

In the following description, for purposes of explanation, specific numbers, times, structures, protocol names, and other parameters are set forth in order to provide a thorough understanding of the present invention. However, it will be apparent to anyone skilled in the art that the presented invention may be practiced without these specific details. In other instances, well-known components and modules are shown in block diagram in order not to obscure the present invention unnecessarily.

General Method Embodiment

The present invention provides a means for a first communication node (UE) to notify a second communication node (P-GW) via an indication on when a new QoS path needs to be dynamically configured. In addition, this indication could also carry the meaning for UE to instruct P-GW to generate another set of filtering rules (i.e. routing filters or packet filters) for the other interfaces of UE based on the filter description sent along with the indication. The P-GW, based on the indication provided by the UE, would proceed to setup a new QoS path for the UE and/or dynamically configure filtering rules for the new QoS path to the UE. The benefit for the above action is that the savings in the battery power for the UE and the number of message exchanges between the UE and P-GW.

### Embodiment 1

### UE Notifying P-GW via DSMIP BU

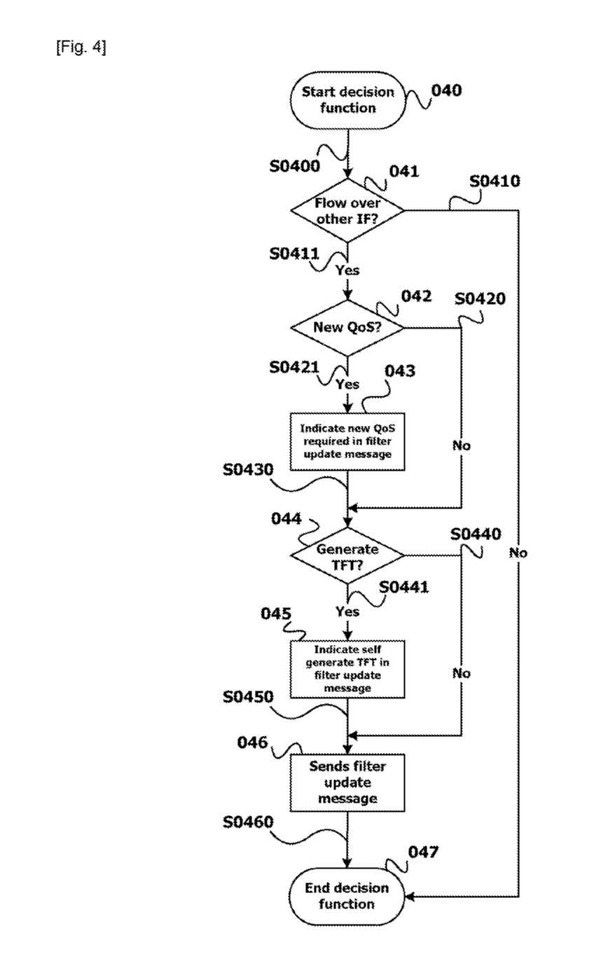

Prior to indicating the user's intention to the P-GW, a decision function in the UE would need to conclude if this indication has to be sent to the P-GW. FIG. 4 depicts a flow chart on how the decision for notifying P-GW of user's intention is made by the UE according to one preferred embodiment of this invention.

For this embodiment, the function starts (040) when UE 0100 receives a data packet that does not match any filtering rules (i.e. routing filters or packet filters) that UE 0100 has. Alternatively, the function starts when UE 0100 receives a data packet with a modification of QoS parameters for that particular data packet flow. The function continues (S0400) to check if the received data packet flow is to be routed over another interface of UE 0100 (041). This check could be, but not restricted to, a Graphic User Interface (GUI) query to the user or a locally stored user pre-configured policy in UE 0100.

If the check deems that the flow has no preference of interfaces (S0410), the function proceeds to terminate (047). If the check deems that the flow has a preference of interfaces (S0411), the function carries on by determining if the data path requires UE 0100 to negotiate for a new QoS value for the data packet flow (042). If it is determined that no new QoS value is required, the function moves ahead (S0420). If a new QoS value is needed (S0421), the function informs UE 0100 that the filter update message would have to contain a request for the desired QoS value (043).

The function continues (S0430) to decide if the user wants P-GW 0104 to generate a TFT for the requested data path (044). This decision could be, but not limited to, a Graphic User Interface (GUI) query to the user or a locally stored user pre-configured policy in UE 0100. If no request is made for P-GW 0104 to generate TFT, the function moves on (S0440). If a request is triggered for P-GW 0104 to generate TFT (S0441), the function tells UE 0100 that the filter update message would have to notify P-GW 0104 to generate TFT based on the routing filter description of the filter update message (045). When all the decisions are done (S0450), the function proceeds to ask UE 0100 to send the filter update message to P-GW 0104 based on the intention of the user (046). Once the filter update message has been trigger to be sent (S0460), the function terminates (047).

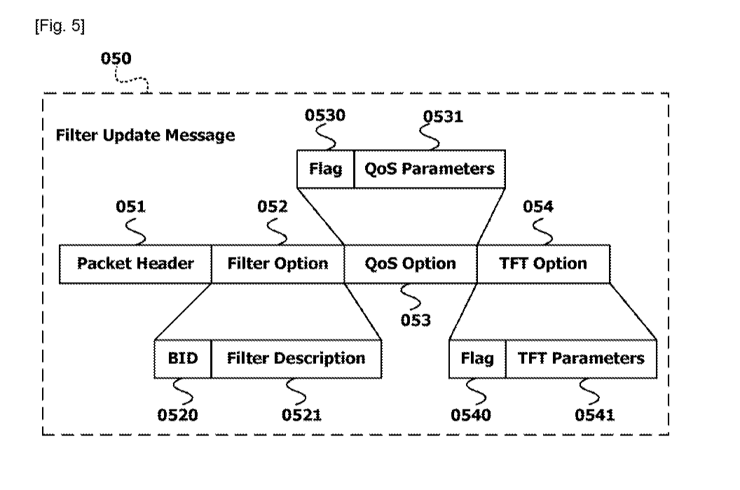

With the decision on how UE 0100 can notify P-GW 0104 based on the user's intention, the format of the filter request message would now be explained. FIG. 5 illustrates a preferred message format for the filter update message (050) according to a preferred embodiment of the invention. The message format in FIG. 5 comprises a Packet Header (051), a Filter Option (052), a QoS Option (053) and a TFT Option (054). This message could be, but not limited to, a control message (e.g. BU message. IKEv2 message) or the Protocol Configuration Option (PCO) in any access specific message used for communication between UE and a network entity (e.g. S-GW, Access Gateway, ePDG, P-GW) in non-3GPP access. If UE 0100 is using the network based mobility protocol (PMIP: Proxy Mobile IP) in non-3GPP access, it is preferable that the PCO is used by UE 0100 and eventually it reaches the P-GW by PBU (Proxy Binding Update) message sent by S-GW, Access Gateway or ePDG.

The Packet Header (051) encompasses the origin of the message and could typically consist of, but not limited to, an IPv4 or IPv6 address, a type field to indicate the type of message and a length field to indicate the length of the message. The Filter Option (052) further comprises a BID (0520) and a Filter Description (0521). The BID (0520) is a unique binding identifier that allows UE 0100 to distinctly identify each of UE 0100 data paths. The Filter Description (0521) contains the information of data packet flows that UE 0100 wants P-GW 0104 to route to the specific BID.

The QoS Option (053) may further comprise a Flag (0530) and a QoS Parameters (0531). The purpose of Flag (0530) is to let P-GW 0104 knows if UE 0100 requires a new QoS data path to be setup to UE 0100. Preferably, the new QoS data path would be created to the interface that is mapped to BID (0520). The optional QoS Parameters (0531) allows UE 0100 to specify the desired QoS values for the new data path to P-GW 0104. If not present, the network node may obtain the QoS levels elsewhere (e.g. through information from a PCRF).

The TFT Option (054) may further comprise a Flag (0540) and a TFT Parameters (0541). The purpose of Flag (0540) is to inform P-GW 0104 that a TFT can be generated based on the Filter Description (0521) contained in the same update message. Preferably, the TFT would be applied to the interface that is mapped to BID (0520). The optional TFT Parameters (0541) permits the UE 0100 to define the granularity for the TFT that is to be generated by P-GW 0104. If the TFT Parameters field is not present, the network may use a default granularity to generate the TFT.

With the format of the filter update message sent by UE 0100 to P-GW 0104 described, the following would explain how P-GW 0104 processes a received routing filter request message. FIG. 6 shows a flow chart on how a P-GW processes the filter update message according to a preferred embodiment of the invention. The function starts (060) when P-GW 0104 receives a filter request message (050) from UE 0100. The function proceeds (S0600) to check if the QoS Option (053) has been specified in the filter update message (061). If the QoS Option (053) has not been specified (S0610), the function terminates (069). Preferably, when a filter update message (050) is received with the QoS Option (053) not specified, the filter update message (050) is sent to the prior art filter processing functions as described in Non-Patent Document 2, Non-Patent Document 3 and Patent Document 1.

If the function checks that the QoS Option (053) has been specified (S0611), the function continues to verify with the PCRF 0106 if UE 0100 is allowed to have the requested QoS value for the new QoS data path (062). Based on the response from PCRF 0106, the function moves ahead (S0620) to determine if the desired QoS value data path can be granted (063). If UE 0100 is not granted the desired QoS value data path (S0630), P-GW 0104 will notify UE 0100 in a response message that the desired QoS value data path was not granted (064). The function terminates (S0640) after notifying UE 0100 (069).

If UE 0100 is granted the desired QoS value data path (S0631), the functions continues to decide if P-GW 0104 needs to generate a TFT for the QoS data path (065). If the TFT Option (054) in the filter update message (050) is not specified (S0650), the function proceeds to notify the UE in a response message that the desired QoS data path has been granted (066). The function terminates (S0660) after notifying UE 0100 (069). If the TFT Option (054) in the filter update message (050) is specified (S0651), the function moves on by telling P-GW 0104 to generate the TFT for the desired QoS data path (067). Preferably, for this embodiment, the TFT would be generated based on the Filter Description (0521) in the filter update message. Also, the P-GW 0104 would use the TFT Parameters (0541) to define the granularity for the TFT. The function continues (S0670) to tell the UE in a response message that the desired QoS data path has been granted and the TFT for that QoS data path has be generated (068). The function terminates (S0680) after notifying UE 0100 (069).

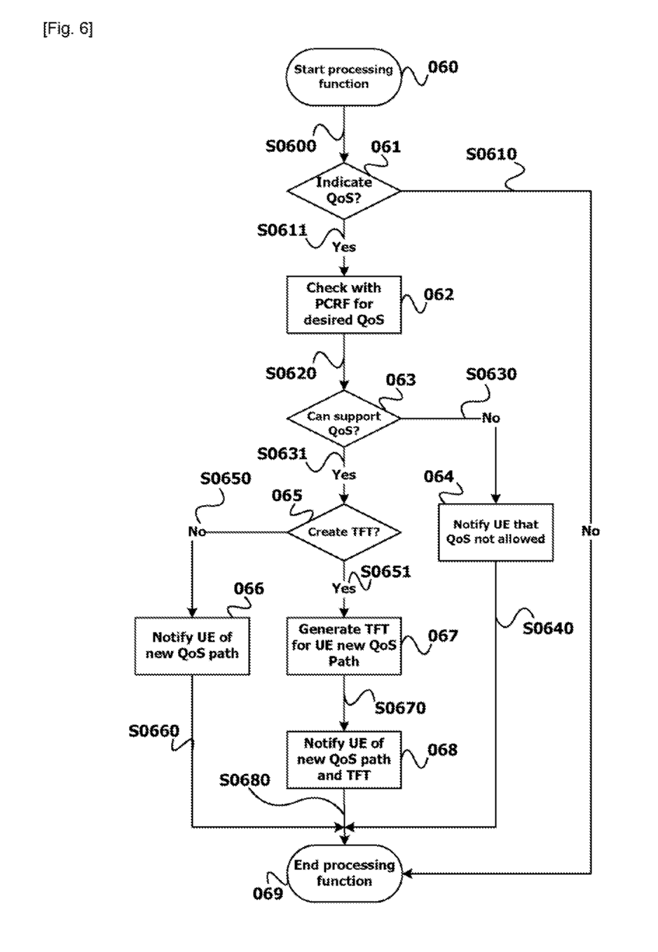

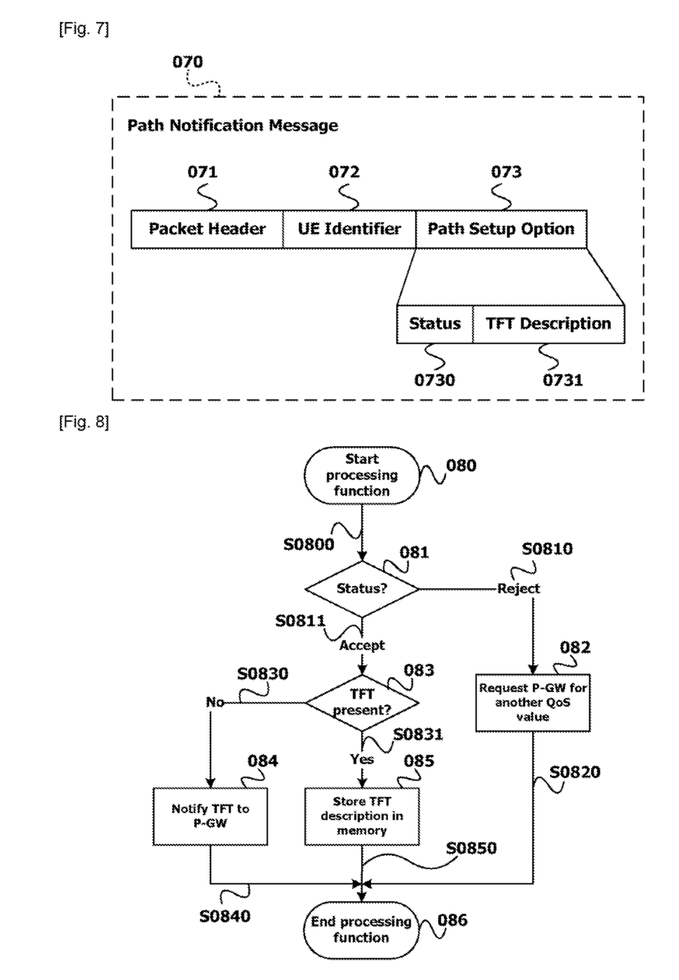

With the explanation on how a P-GW would process the filter request message, the following describes the response message that P-GW sends to UE to indicate the data path setup request made by UE. FIG. 7 shows a preferred message format of a path notification message sent by P-GW according to a preferred embodiment of the invention. The path notification message (070) comprises a Packet Header (071). a UE Identifier (072) and a Path Setup Option (073).

The Packet Header (071) encompasses the origin of the message and could typically consist of, but not limited to, an IPv4 or IPv6 address, a type field to indicate the type of message and a length field to indicate the length of the message. The UE Identifier (072) allows P-GW 0104 to tell entitles in the EPS 010 that the UE is targeted to receive this path notification message (070). Preferably, the UE Identifier could be, but not limited to, the International Mobile Subscriber Identity (IMSI) of the UE.

The Path Setup Option (073) comprises a Status (0730) and a TFT Description (0731). The Status (0730) indicates to UE 0100 if P-GW 0104 has granted the setting up of UE 0100 desired QoS data path. The TFT Description (0731) would contain the TFT that was generated by P-GW 0104 at UE 0100 request.

FIG. 8 explains how UE processes a received Path Notification message (070). The function starts (080) with UE 0100 receiving the Path Notification message from P-GW 0104. The function continues (S0800) to determine if P-GW 0104 has granted the request for a desired QoS data path to UE 0100 (081). If P-GW 0104 rejects UE 0100 request (S0810), UE 0100 can proceed to make another request to P-GW 0104 for another QoS value data path (082). The function moves on (S0820) to terminate after UE 0100 has been triggered to send the request (086).

If P-GW 0104 accepts UE 0100 request (S0811), the function moves ahead to check if the TFT is present in the TFT Description (0731) (083). If the TFT is not present (S0830), the function proceeds to get UE 0100 to notify the TFT to P-GW 0104 (084). The function moves on (S0840) to terminate after UE 0100 has been triggered to send the TFT to P-GW 0104 (086). Preferably, for this embodiment, the reason why UE 0100 has to sent TFT to P-GW 0104 could be, but not restricted to, that policies within P-GW 0104 do not allow P-GW 0104 to generate TFTs on behalf of UE 0100. If the TFT is present (S0831), the function continues to store the TFT in the volatile memory space of UE 0100 (085). The function moves on (S0850) to terminate after UE 0100 has been triggered to store the TFT (086).

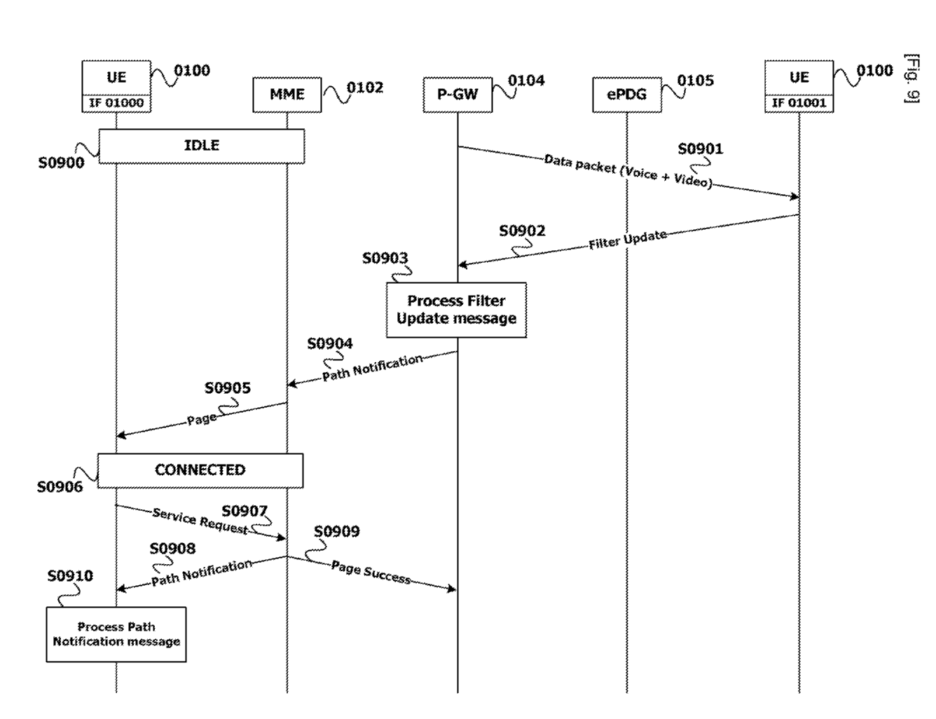

With the various decision functions and message formats described so far in this preferred embodiment of the invention, the following explanation provides a summary of the actions taken by the various entities according to this invention. FIG. 9 illustrates a message sequence chart that depicts the whole process taken according to a preferred embodiment of the invention. UE 0100 has two interfaces simultaneously connected to EPS 010. IF 01000 is a cellular radio interface that is connected via MME 0102 to P-GW 0104 and is currently in idle state (S0900). IF 01001 is a WLAN radio interface that is connected via ePDG 0105 to P-GW 0104. A correspondent node (CN 0110) starts a video conferencing call to UE 0100, where the video conferencing data packets begin arriving at P-GW 0104. Preferably, for this example, the video conferencing data packets consist of voice data packets and video data packets.

As P-GW 0104 knows that IF 01001 is currently connected, P-GW 0104 sends the video conferencing data packet to IF 01001 (S0901). The user of UE 0100 decides that the voice data packets has QoS requirements and wants the voice data packets to be routed via IF 01000 (as that connection can guarantee certain levels of QoS). Likewise for the video data packets, the user of UE 0100 decides to have them routed via IF 01001. Since UE 0100 understands that IF 01000 is currently in idle state and the default bearer is not able to support the QoS requirement for voice data packet, UE 0100 decides to ask P-GW 0104 to create a new QoS path with the desired QoS for voice data packet to IF 01000. Furthermore, to reduce the amount of signalling UE 0100 has to perform, UE 0100 also ask P-GW 0104 to generate the TFT based on the routing filter description. With this decision, UE 0100 sends a filter update message to P-GW 0104 to convey the user's request (S0902).

For this example, IF 01000 is assigned BID1 and IF 01001 is assigned BID2. We assume that the IP address of CN 0110 is Addr1 with the voice data packet on port number #2300 and video data packet on port number #2400. Hence, the filter update message in S0902 would look something like the following:

Filter Option (052)

BID (0520)==BID1;

Filter Description (0521)==Addr1, #2300;

QoS Option (053)

Flag (0530)==‘1’;

QoS Parameters (0531)==‘80%’;

TFT Option (054)

Flag (0540)==‘1’;

TFT Parameters (0541)==Use Source Address field only;

Filter Option (052)

BID (0520)==BID2;

Filter Description (0521)==Addr1, #2400;

P-GW 0104 will process (S0903) the above filter update message with the following results. P-GW 0104 understands that UE 0100 wants voice data packets (Addr1, #2300) to be routed to IF 01000. Also, with Flag (0530) set to a value of ‘1’, it lets P-GW 0104 to know that UE 0100 wants a new QoS data path (of 80% QoS) to be created now to IF 01000. For this action, P-GW 0104 would have to consult with PCRF 0106 to determine if the desired QoS level is allowed. Furthermore, Flag (0540) is set to a value of ‘1’ which allows P-GW 0104 to recognize that P-GW 0104 is asked by UE 0100 to generate the TFT for the new QoS data path to IF 01000. Also, it further indicates in the TFT Parameters (0541) that the TFT only need to have the source address (Addr1). This means P-GW 0104 can generate a TFT and mapped it to the new 80% QoS data path with a packet filter that says only Addr1 packets can use this QoS path. Subsequently, the next Filter Option implies that video data packet (Addr1, #2400) will be routed to IF 01001.

With the filter update message processed by P-GW 0104, P-GW 0104 sends the Path Notification message (070) to MME 0102 (S0904). The Path Notification message would indicate Status (0730) as ‘Ok’ with the generated TFT from P-GW 0104 in the TFT Description (0731). MME 0102 will proceed to page for UE 0100 (S0905).

When IF 01000 receives the page message, it turns on the transmitter of IF 01000 thereby, getting IF 01000 in connected state (S0906). IF 01000 proceeds to respond MME 0102 with a service request message (S0907). MME 0102, upon receiving the service request message from IF 01000, forwards the Path Notification message from P-GW 0104 to IF 01000 (S0908). Concurrently, MME 0102 tells P-GW 0104 that UE 0100 has been located within EPS 010 (S0909). UE 0100 processes the Path Notification message (S0910) to understand that the QoS data path has been granted and stores the TFT that is associated with this QoS path.

It would be obvious to a person skilled in the art that the method described in having the P-GW self-generate TFT based on routing filter is different from the method explained in Patent Document 3. In this prior art, the P-GW uses the information of an uplink packet from the UE to self-generate a routing filter for the downlink packets matching the uplink flow. However, this prior art does not explain if the UE would send any indication to tell the P-GW if the self-generation action is required. This lack of indication implies that in the prior art, the P-GW would always generate a routing filter for any uplink flow that UE sends. For this invention, the UE would send an indication (Flag 0540) in the filter update message to the P-GW. The presence of Flag 0540 allows P-GW to understand if the UE has the intent to request P-GW to generate the TFT for the UE. Herein, lies the difference between the present invention and this prior art.

It should be obvious to a person skilled in the art that the method described in having the P-GW self-generate TFT based on routing filter is different from the method explained in Patent Document 5. In this prior art, a network controlled flow mobility operation is described by having a P-GW interact with a Flow Management Enforcement Function which decides the routing filters for a UE. However, if the packets are encapsulated, i.e. transmitted through a VPN tunnel, the network does not know the type of flow it is routing and hence might not make a good decision for the UE on how a flow is to be routed based on the flow characteristics. For this invention, the UE would be the entity that suggests how a flow is to be routed. The network, of course, has the capabilities to amend or reject the suggestions from the UE.

### Embodiment 2

### UE Notifying Pointer or Reference to TFT to P-GW

In another preferred embodiment of the invention, the user of UE 0100 could have already pre-established a secondary bearer with the associated TFT prior to the start of the video conferencing call. As IF 01000 is currently in idle mode, this implies that this secondary bearer is currently inactive. However, as EPS 010 supports fast bearer re-establishment, the information of the secondary bearer is already stored in MME 0102 and P-GW 0104. With IF 01000 been in idle state, user also decides to conserve the battery usage for IF 01000 by setting IF 01001 as the default path used by P-GW 0104.

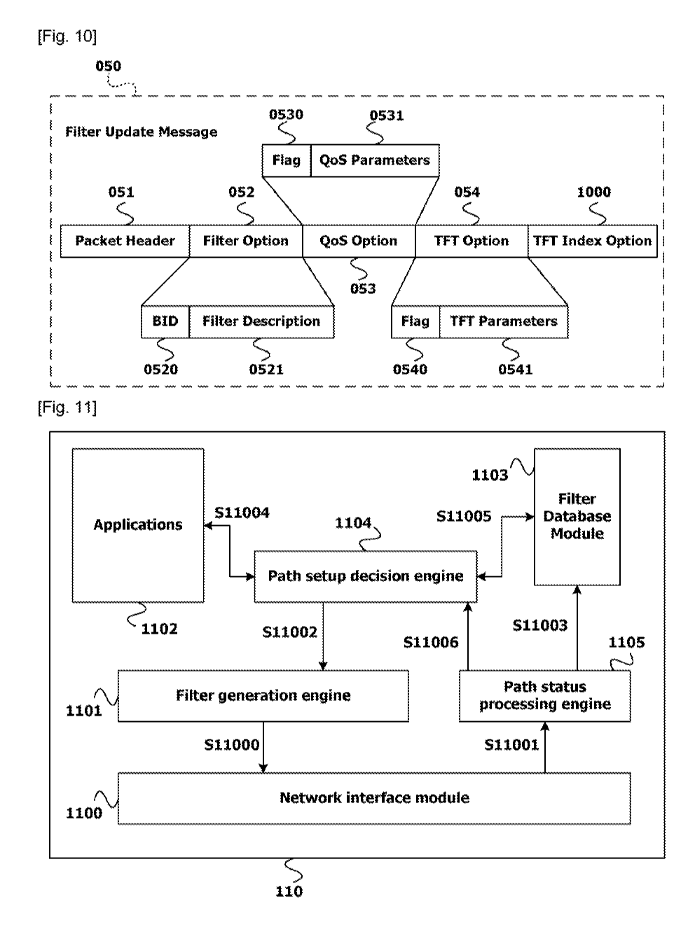

FIG. 10 illustrates the message format as described in FIG. 5 with the addition of a new TFT Index Option according to a preferred embodiment of this invention. As UE 0100 knows that P-GW 0104 already has the TFT for the video conferencing data packet flow, the filter update message (050) further comprises a new option called the TFT Index Option 1000. This TFT Index Option 1000 would contain a reference pointer to the TFT that P-GW 0104 already knows. If P-GW 0104 processes the filter update message with the TFT Index Option 1000 present, P-GW 0104 would activate the particular secondary bearer the TFT Index Option 1000 is pointing to for UE 0100. The benefit for this is that the filter update message size is reduced—with the TFT Index Option 1000, the need to specify the routing filter description is omitted.

The following is an example that describes the above in greater detail. User generates a TFT called Index 1 for a secondary bearer on IF 01000. This is to prepare IF 01000 for a video conferencing call that the user knows which is going happen soon. IF 01000 enters idle state and IF 01001 becomes the default data path between UE 0100 and P-GW 0104. When the video conferencing data packet arrives at IF 01001 from P-GW 0104, UE 0100 understands that for this data packet flow, the TFT has already been prepared. Hence, IF 01001 sends a filter update message (050) with the value of the TFT Index Option 1000 set to ‘Index1’. When P-GW 0104 receives this filter update message, it knows that a TFT has already been created for one of the secondary bearers and matches the video conferencing data packet flow the TFT with Index1.

Alternatively, the TFT Index Option 1000 can be carried via other type of signalling or data messages. The signalling or data message could be, but not limited to, a control message (e.g. BU message, IKEv2 message) or the Protocol Configuration Option (PCO) in any access specific message used for communication between UE and a network entity (e.g. S-GW, Access Gateway, ePDG, P-GW) in 3GPP or non-3GPP access. If UE 0100 is using the network based mobility protocol (PMIP: Proxy Mobile IP or GTP (GPRS tunneling Protocol)) in 3GPP or non-3GPP access, it is preferable that the PCO is used by UE 0100 and eventually it reaches the P-GW by PBU (Proxy Binding Update) message or any GTP message sent by S-GW, Access Gateway or ePDG.

### Embodiment 3

### UE Does Not Need to Add BID in BU

In another preferred embodiment of the invention, as an optimization, the filter update message (050) sent by the UE need not contain any BID 0520. When P-GW processes a filter update message without any BID present, P-GW understands that UE wants to move particular flow from one of UE's interface to another of UE's interface. The benefit for this embodiment is that bytes can be saved in the filter update message as the BID fields need not be used.

The following example describes this embodiment with more clarity. User decides to move a VoIP packet flow from IF 01001 (BID2) to IF 01000 (BID1). UE 0100 sends the filter update message to P-GW 0104 that has all fields in the filter request message (050) specified except for BID 0520. P-GW 0104 treats the reception of such filter request message as an indication that UE 0100 wants to move the VoIP packet flow from IF 01001 to IF 01000.

### Embodiment 4

### UE Notifying 3G Cell-ID to P-GW

In yet another preferred embodiment, as a further optimization, the filter update message sent by UE to P-GW could contain the cell identifier that IF 01000 is located within. The benefit of this embodiment is that with the notification of cell identifier, the MME can page for UE in a smaller subset of EPS 010.

For example, IF 01001 informs P-GW 0104 of the cell identity (via filter update message) that IF 01000 is currently located in. P-GW 0104 informs MME 0102 of the cell identity that IF 01000 is within. When MME 0102 needs to page for IF 01000, MME 0102 uses the cell identity as a guide and pages IF 01000 within a smaller subset of EPS 010.

### Embodiment 5

### P-GW Tells S-GW of Routing Filter to Generate TFT

In another preferred embodiment, if EPS 010 deploys Proxy Mobile IPv6 protocol, P-GW 0104 could provide the S-GW 0103 with the appropriate routing filter for UE 0100. For this embodiment, S-GW 0103 serves like a mobility anchor point for UE 0100 data packets. Hence, by having P-GW 0104 inform S-GW 0103 of the routing filter, it allows for S-GW to have the similar routing filter to TFT mapping functionality as the P-GW described in this invention.

### Embodiment 6

### UE Takes the Initiative to Get the Path Ready First

In yet another preferred embodiment, a decision function in UE 0100 permits UE 0100 to decide to initiate a path setup on IF 01000 prior to sending a filter update message on IF 01001 to P-GW 0104. The benefit of this embodiment is that the user would not experience delay in reception of voice and video data packets. In this case, it is preferable that P-GW 0104 does not page for IF 01000 as described in the following embodiment 7. In this embodiment, UE 0100 may send any message including the content of the filter request message to P-GW 0104 in the course of path set up procedures on IF 01000. For example. UE 0100 can send a modify bearer message with information to be included in the filter request message, thereby IF 01001 need not to send the filter request message.

For example, IF 01001 receives a video conferencing call data packet flow from P-GW 0104. User wants to filter this data flow with voice data packets being routed to IF 01000 and video data packets routed to IF 01001. However, as user does not want to experience delay in receiving both the voice and video data packets, UE 0101 decides to setup the path on IF 01000 with the appropriate QoS signalling prior to sending the filter update message to P-GW 0104 to start filtering the data packets.

### Embodiment 7

### P-GW Tells MME not to Page for UE

In another preferred embodiment, when P-GW receives a filter request from UE, P-GW can immediately setup the path to IF 01000. However, P-GW would tell MME not to page for IF 01000. This will prevent IF 01000 from turning on its transmitter function while in idle state and has the benefit of saving UE's battery.

For example, P-GW 0104 receives a filter update message from UE 0100 to create a new TFT based on routing filter for a VoIP data packet flow to IF 01000. As UE 0100 indicates that this data flow is starting soon, P-GW 0104 decides to optimize on the amount of time IF 01000 gets into connected state in order to save battery for UE 0100. P-GW 0104 informs MME 0102 of the information for the secondary bearer and TFT. P-GW 0104 also instructs MME 0102 not to page for IF 01000. In the case that UE 0100 decides to initiate a path setup on IF 01000 in parallel with sending a filter request message, it is possible for UE 0100 to inform P-GW 0104 that P-GW 0104 need not to setup the path to IF 01000.

### Embodiment 8

### Multiple PMIP Connection

In yet another preferred embodiment, if both interfaces of UE 0100 use the network based mobility protocol (Proxy Mobile IPv6 or GTP), the bearers that are setup for access in EPS 010 could be identified to the respective interface of UE 0100. For this preferred embodiment, UE 0100 could indicate an interface label. This interface label may refer to a 3GPP access or a non-3GPP access and could be included in the bearer set up message. This will be passed from the UE to the S-GW by PCO in any access specific message and eventually reach the P-GW by PBU (Proxy Binding Update) message or any GTP message. In this way, the P-GW will forward packets to the appropriate 3GPP bearer or non-3GPP tunnel (e.g. GTP-based tunnel to the ePDG or otherwise) based solely on TFTs information alone. The benefit of this embodiment is that it removes the need to run host-based mobility protocol (e.g. Dual Stack Mobile IPv6) for telling P-GW of routing filter.

One way of implementing this is to insert the interface label into a TFT. This way, the P-GW would know that packet filters specified in a TFT could be used to match received data packets and identify which interface of the UE to forward these packets to.

Another way of implementing this is to create virtual bearers for non-3GPP accesses. This can be established by sending an EPS Bearer Modification message with a special indication sent to the MME. The MME will proceed to pass this special indication to the Serving Gateway (S-GW) in a Bearer Resource Command message. In turn, the S-GW will pass this special indication to the P-GW in a Bearer Resource Command message. The special indication will tell the P-GW that the UE is requesting for a virtual bearer to be created for a non-3GPP access (the special indication may contain the interface identifier to identify which non-3GPP access is mapped to the virtual bearer). The P-GW will then trigger the necessary network signalling to the S-GW to set up this virtual bearer. Each virtual bearer will behave like a normal EPS bearer and may have associated TFT which specifies the packets filters. Hence, the P-GW can match a received packet to the packet filters of TFT associated with each virtual bearer to determine which bearer to forward the packet. Each virtual bearer may map to an actual 3GPP bearer, or a non-3GPP access identified by the interface label.

### Embodiment 9

### Multiple Connections via PMIP and DSMIP Using IF-ID and Virtual Bearers

In another preferred embodiment, a 3GPP interface (i.e. cellular) of UE 0100 uses the network based mobility protocol while a non-3GPP interface (i.e. WLAN) of UE 0100 uses the host-based mobility protocol. For this preferred embodiment, when UE 0100 sends a BU message to P-GW 0104 to convey the filtering rules containing routing filters, UE 0100 could indicate an interface label identifying UE 0100 various interfaces for flow filtering in the BU. The benefit of this embodiment is that P-GW 0104 need not use TFT to route packets to the 3GPP interface of UE 0100, thereby localizing the filtering rules containing routing filters to the Mobile IP protocol stack (i.e. DSMIP routing filters). In addition, the EPS Bearer identity could also be conveyed in the BU for those routing filters to the 3GPP interface of UE 0100. The inclusion of the EPS Bearer identity would allow P-GW 0104 to know which radio bearer to route the packet to UE 0100 over the 3GPP interface.

Another way of implementing this is to create virtual bearers for 3GPP accesses. This can be established by sending an EPS Bearer Modification message with a special indication sent to the MME. The MME will proceed to pass this special indication to the Serving Gateway (S-GW) in a Bearer Resource Command message. In turn, the S-GW will pass this special indication to the P-GW in a Bearer Resource Command message. The special indication will tell the P-GW that the UE is requesting for a virtual bearer to be created a non-3GPP access (the special indication may contain the interface identifier to identify which non-3GPP access is mapped to the virtual bearer). The P-GW will then trigger the necessary network signalling to the S-GW to set up this virtual bearer. Each virtual bearer will behave like a normal EPS bearer and may have associated TFT which specifies the packets filters. Hence, the P-GW can match a received packet to the packet filters of TFT associated with each virtual bearer to determine which bearer to forward the packet. Each virtual bearer may map to an actual 3GPP bearer, or a non-3GPP access identified by the interface label. The benefit of doing this instead of using routing filter descriptors in BU signalling is that this way, only TFTs are created for packet routing. So, there is no multiple level of filters being installed (like the case of DSMIP routing filters and then 3GPP TFTs) which may have synchronization issues.

### Embodiment 10

### P-GW to Generate Routing Filters Based on TFTs

In order to solve the synchronization issues between DSMIP routing filters and 3GPP TFTs, in another preferred embodiment, the UE can request the P-GW to self-generate the routing filters based on the TFTs associated with the 3GPP bearers. For example, the UE sends an EPS Bearer Modification request message to the MME. In this request message, the UE will indicate that the P-GW to self-generate the routing filters based on the indicated TFTs. For this embodiment, the indication could be, but not limited to, an information element specifying the routing filter identity, the binding identifier and the packet filter identity. The MME will proceed to pass this new information element to the S-GW in a Bearer Resource Command message. In turn, the S-GW will pass this new information element to the P-GW in a Bearer Resource Command message. The P-GW, when receiving this new information element, processes it and generates the corresponding routing filters based on the TFT indicated in the information element. For example, if the Bearer Resource Command message states:
EPS Bearer Identity: 0001
Packet filter identifier: 0000 0100 0001 0100.
Flow Identifier: FID 1.
Binding Identifier: BID assigned to IF 01001.

The P-GW will generate the routing filters as:
Filtering rules at P-GW
Flow Identifier: FID 1.
Binding Identifier: BID assigned to IF 01001.
Routing filter contents: Contents taken from packet filter 0000 0100 0001 0100.

Apparatus Embodiment—UE

FIG. 11 shows the functional architecture 110 of a preferred apparatus (for example, UE 0100), comprising a network interface module 1100, a filter generation engine 1101, a filter database module 1103, Applications 1102, a path setup decision engine 1104 and a path status processing engine 1105. This preferred apparatus might be, but not restricted to, any mobile electronic communication device such as a mobile phone or a laptop for the various preferred embodiments of this invention.

The network interface module 1100 is a functional block that encompasses all the hardware and software necessary for the preferred apparatus to communicate with another node via some communications medium. Using terminology well-known in the relevant field of art, the network interface module 1100 would represent communications components, firmware, drivers, and communications protocols of Layer 1 (Physical Layer) and Layer 2 (Data Link Layer). A person skilled in the art would appreciate that the functional architecture 110 may contain one or more network interface module 1100. The signal/data path S11001 allows the network interface module 1100 to provide triggers/packets transmission to the path status processing engine 1105. For example, the network interface module 1100 would forward any path setup messages (e.g. path notification message 070) it receives to the path status processing engine 1105 for processing.

The filter generation engine 1101 is a functional block that handles the generation of messages to convey the various routing decisions for this preferred apparatus. The signal/data path S11000 allows the filter generation engine 1101 to provide triggers/packets transmission to the network interface module 1100. For example, the filter generation engine 1101 would forward any filter update messages 050 it generates to the network interface module 1100 for transmission.

The Applications 1102 represents a functional block that encompasses all the protocols and programs that sit on top of the network layer in a communications stack. This includes any transport or session layer protocol, such as the Transmission Control Protocol (TCP), Stream Control Transport Protocol (SCTP), and User Datagram Protocol (UDP), or programs and software that need to communicate with other nodes. The signal/data path S11004 allows triggers to be transfer from the path setup decision engine 1104 to appropriate program in Applications 1102. Similarly, the signal/data path S11004 also permits triggers to be sent from the Applications 1102 to the path setup decision engine 1104. According to a preferred embodiment of the invention, these triggers let the path setup decision engine 1104 to query and get feedback from users via Applications 1102 on the requirement for setting up a data path for a particular data flow.

Also, in the functional architecture 110 of this preferred apparatus, the filter database module 1103 provides storage of necessary information required by the functional architecture 110. In our preferred apparatus, the filter database module 1103 typically comprises a single or plurality of routing filters and/or TFTs for the various packet data flows of the user. The filter database module 1103 also can contain the policy for routing of traffic flow. One example is that the traffic flow policies are sent to the UE either via the 3GPP access or the non-3GPP access by a network entity known as Access Discovery and Selection Function (ANDSF) of different operators. The policy is carried by the message from ANDSF to the UE. The traffic flow policies allow operators to specify how a particular traffic flow is to be routed. The signal/data path S11005 allows triggers to be transfer from the path setup decision engine 1104 to the filter database module 1103. Similarly, the signal/data path S11005 also permits packets to be sent from the filter database module 1103 to the path setup decision engine 1104. According to a preferred embodiment of the invention, this interaction allows the path setup decision engine 1104 to query and obtain routing filters or TFTs to aid in the setting up a data path for a particular data flow.

This invention introduces the path setup decision engine 1104 where the objective is to decide if a particular data flow requires a new data path to be established to the preferred apparatus 110. An example is that the path setup decision engine 1104 uses information from the filter database module 1103 along with the feedback from the user via Applications 1102 to decide if a new QoS data path is needed to the preferred apparatus 110. Additionally, the path setup decision engine 1104 also uses the information and feedback to decide if a request is to be made to the P-GW for self-generating TFT from routing filter. The signal/data path S11002 allows triggers to be sent to the filter generation engine 1101 to assist in the generation of the filter update message 050.

Also, this invention introduces the path status processing engine 1105 where the objective is to identify the status for a particular request for a new QoS path or a request for P-GW to self-generate TFT. An example is that the path status processing engine 1105 processes the path notification message 070 or the policy notification message received from network interface module 1100 to identify the status of a particular request made by said preferred apparatus 110. The signal/data path S11003 allows packets (e.g. TFTs) to be sent to the filter database module 1103 for storage and the signal/data path S11006 allows policies to be sent to the path setup decision engine 1104. Another example is that the path status processing engine 1105 processes the data packet received from network interface module 1100 and sends it to the path setup decision engine 1104 by using the signal/data path S11006.

Apparatus Embodiment—P-GW

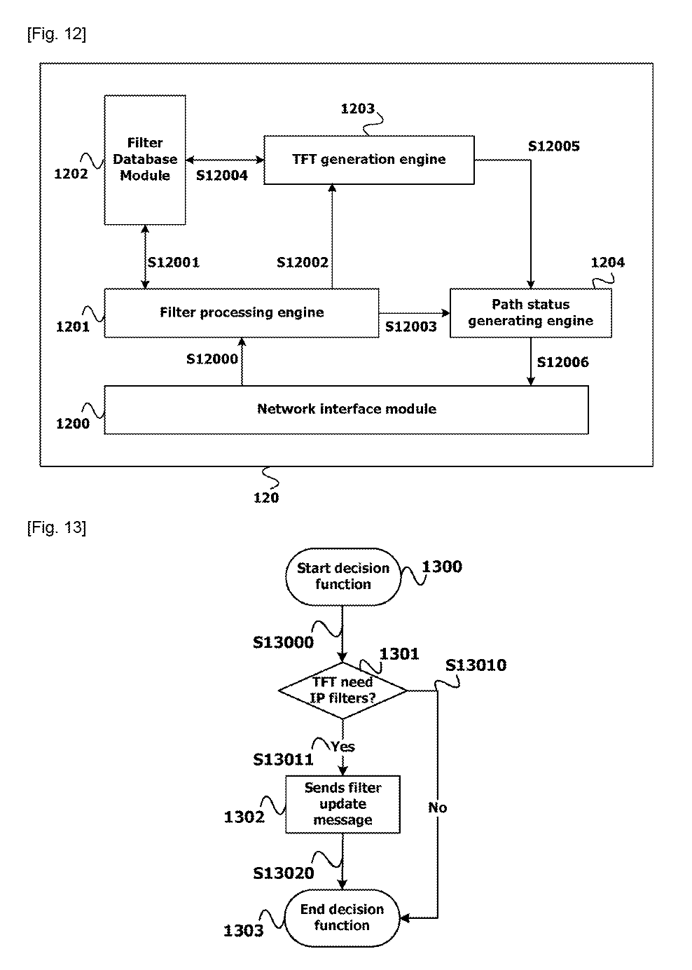

FIG. 12 shows the functional architecture 120 of another preferred apparatus (for example, P-GW 0104), comprising a network interface module 1200, a filter processing engine 1201, a filter database module 1202, a TFT generation engine 1203 and a path status generating engine 1204. This preferred apparatus might be, but not restricted to, any server communication device such as a packet data network gateway or a serving gateway for the various preferred embodiments of this invention.

The network interface module 1200 is a functional block that encompasses all the hardware and software necessary for the preferred apparatus to communicate with another node via some communications medium. Using terminology well-known in the relevant field of art, the network interface module 1200 would represent communications components, firmware, drivers, and communications protocols of Layer 1 (Physical Layer) and Layer 2 (Data Link Layer). A person skilled in the art would appreciate that the functional architecture 120 may contain one or more network interface module 1200. The signal/data path S12000 allows the network interface module 1200 to provide triggers/packets transmission to the filter processing engine 1201. For example, the network interface module 1200 would forward any filtering messages (e.g. filter update message 050) it receives to the filter processing engine 1201 for processing.

The filter processing engine 1201 is a functional block that handles the processing of messages that convey the various routing decisions to this preferred apparatus 120. The signal/data path S12001 allows the filter processing engine 1201 to interact with the filter database module 1202 to store/retrieve routing filter or TFT for processing. For example, the filter processing engine 1201 would store any routing filter contained in filter update messages 050 in filter database module 1202. Also, the filter processing engine 1201 uses signal/data path S12002 to trigger the TFT generation engine 1203 to generate TFTs based on routing filter if the filter update message 050 specifies such request. In addition, the filter processing engine 1201 uses signal/data path S12003 to trigger the path status generating engine 1204 to send a response back to the originator of a filter update message 050.

Also, in the functional architecture 120 of this preferred apparatus, the filter database module 1202 provides storage of necessary information required by the functional architecture 120. In our preferred apparatus, the filter database module 1202 typically comprises a single or plurality of routing filter and/or TFTs for the various packet data flows of the user. The signal/data path S12004 allows interaction between the filter database module 1202 and the TFT generation engine 1203 exchange triggers/packets. According to a preferred embodiment of the invention, this interaction allows the filter database module 1202 to provide routing filter and/or TFTs to aid the TFT generation engine 1203 to generate TFTs from routing filter or vice versa.

This invention introduces the TFT generation engine 1203 where the objective is to create a TFT from a defined routing filter or vice versa. An example is that when the TFT generation engine 1203 is triggered by the filtering processing engine 1201 to create a TFT from a given routing filter, the TFT generation engine 1203 will query the filter database module 1202 for the said given routing filter. The signal/data path S12005 allows packets (e.g. TFTs) to be sent to the path status generating engine 1204 to be included in the path notification message 070.

### Embodiment 11

### UE Decision to Set Routing Filter Based on TFT

FIG. 13 depicts a flow chart on how the decision is taken by a UE for notifying P-GW of routing filter according to one preferred embodiment of this invention. The process starts (1300) when the UE receives a new TFT or when a current TFT at the UE is modified. The function moves on (S13000) to check if the received TFT would require the UE to create or modify routing filter at the P-GW (1301). For this embodiment, the check could be, but not limited to, the UE determining if a particular traffic flow is to be forwarded from one protocol stack to another protocol stack in the P-GW. if the function deems that the received TFT does not required the creation or modification of routing filter at P-GW (S13010), the process ends (1303) with no further action required by the UE. However, if the function deems that the received TFT requires the creation or modification of routing filter at P-GW (S13011), e.g. if the UE wants to receive the data packet identified by the TFT via the non-3GPP interface, the process will trigger the UE to send a filter update message to P-GW (1302). Once it is determined that the routing filters are set at the P-GW (S13020), the process ends (1303).

The following is an example that describes the above in greater detail. UE 0100 powers on both IF 01000 (assigned HoA for communication) and IF 01001 (assigned CoA for communication) and performs an attach procedure to EPS 010 to achieve simultaneous connection to EPS 010 with IF 01001 being the default communication path. During the attach procedure, the various services that UE 0100 is subscribed to are setup by P-GW 0104. For example, UE 0100 may be subscribed to IMS voice service (source address: IP.Addr1; port number: 2020) that requires a particular level of QoS. Hence, P-GW 0104 creates a dedicated bearer to IF 01000 for transport of IMS voice. For this dedicated bearer, UE 0100 and P-GW 0104 associate a TFT to allow the uplink and downlink of IMS voice traffic to be routed to this dedicated bearer. When UE 0100 sees the creation of such a TFT for IF 01000, UE 0100 will decide if there is a need to setup Mobile IP-based routing filters at P-GW 0101 by sending a BU with filter descriptions. Since the default path is over IF 01001, it implies that UE 0100 knows if P-GW 0104 receives IMS voice traffic, P-GW 0104 will routed the IMS voice traffic to IF 01001 as no DSMIP routing filters are setup at P-GW 0104. Thus, in order for IMS voice traffic to be routed to IF 01000, UE 0100 sends a BU with a filter description that specifies IMS voice traffic (source address: IP.Addr1; port number: 2020) to be routed to HoA. This in turn will allow P-GW 0104 to route the IMS voice traffic to the dedicated bearer created for IF 01000 using the associated TFT.

### Embodiment 12

### UE Decision to Set Routing Filter Based on TFT Using Reference Pointer

In another preferred embodiment, the filter update message that UE sends when triggered by the decision of a new or modified TFT could contain a TFT Index Option as shown in FIG. 10. This message could be, but not limited to, a control message (e.g. BU message, IKEv2 message) or the Protocol Configuration Option (PCO) in any access specific message used for communication between UE and a network entity (e.g. S-GW, Access Gateway, ePDG, P-GW) in non-3GPP access. If UE 0100 is using the network based mobility protocol (PMIP: Proxy Mobile IP) in non-3GPP access, it is preferable that the PCO is used by UE 0100 and eventually it reaches the P-GW via PBU (Proxy Binding Update) message sent by S-GW, Access Gateway or ePDG. If the TFT Index Option is conveyed in the BU message, the format could be, but not restricted to, as a Traffic Selector sub-option. The purpose of using the TFT Index Option to specify a pointer to a TFT already present rather than duplicating the TFT as a filter description with format described in Non-Patent Document 4 is to reduce the message size of the BU.

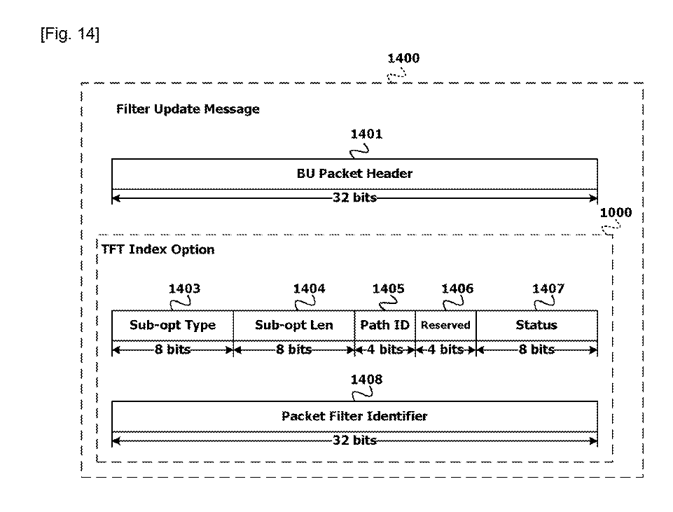

FIG. 14 illustrates a preferred message format for the filter update message (1400) according to a preferred embodiment of the invention. The message format in FIG. 14 comprises a BU Packet Header (1401), and a TFT Index Option (1000). The BU Packet Header 1401 encompasses the origin of the message and could typically consist of, but not limited to, an IPv4 or IPv6 address, a type field to indicate the type of message and a length field to indicate the length of the message. The BU Packet Header 1401 would also include the Binding Identifier Mobility Option which would convey the Binding ID (BID) to uniquely identify the multiple IP address for the UE.

The TFT Index Option 1000, as described in FIG. 10, would contain a pointer to the TFT that P-GW already knows. The TFT Index Option 1000 would typically consist of a Sub-option Type (1403), a Sub-option Length (1404), a Path ID field (1405), a Reserved field (1406), a Status field (1407) and an optional Packet Filter Identifier (1408). The Sub-option Type 1403 uniquely defines the type of option being used, which in this case will be a pointer to TFT (or a packet filter within the TFT). The Sub-option Length 1404 identifies the length of the option in octets. The Path ID field 1405 allows the UE or P-GW to specify the corresponding 3GPP bearers of the UE. In the embodiment, the Path ID field 1405 could be, but not limited to, an EPS bearer Identity or a Network service access point identifier (NSAPI). The Reserved field 1406 is currently unused and should be set to zero by the sender and ignored by the receiver. The Reserved field 1406 allows for future extension in the event if more bits are required to identify the Path ID field 1405. The Status field 1407 indicates the success or failure for the P-GW to generate the matching routing filters based on the corresponding TFT as described in our previous embodiments. This field is typically only relevant when included in the Acknowledgement message sent from the P-GW to UE. Lastly, the optional Packet Filter Identifier 1408 allows the UE or P-GW to identify a packet filter that is included in a TFT of the 3GPP bearer identified by the Path ID field 1405. Hence, the Path ID field (containing the EPS Bearer Identity or the NSAPI together with the Packet Filter Identifier) can be used to uniquely reference a packet filter of the UE. The receiver can then generate the routing rule from the specific packet filter that is uniquely identified. Alternatively, the LIE may choose to omit the Packet Filter Identifier field 1408 from the TFT Index Option 100. In this case, the UE is pointing to the entire set of packet filters contained in the TFT that is associated with the 3GPP bearer (identified by the EPS Bearer Identity or the NSAPI). Hence, the receiver can then generate routing rule based on all the packet filters in the TFT identified as a whole.

The following is an example that describes the above in greater detail. Assuming that UE 0100 receive from P-GW 0104 the following TFTs for IF 01000:
EPS Bearer Identity: 0001
Packet filter identifier: 0000 0100 0001 0100.
Packet filter contents: Source IP address (CN 0110);

Port Number (2300).
EPS Bearer Identity: 0010
Packet filter identifier: 0000 0100 0001 0100.
Packet filter contents: Source IP address (CN 0110);

Port Number (2400).

With the reception of the TFTs by UE 0100, UE 0100 decision process is triggered to evaluate if the corresponding DSMIP routing filter need to be set at P-GW 0104. Once UE 0100 determines that DSMIP routing filter need to be set at P-GW 0104, UE 0100 formats the filter update message 1400 as follows:
Filter Update Message (1400)
BU Packet Header (1401): IF 01000 IP address in the source address field;

P-GW 0104 IP address in the destination address field.
Mobility Binding sub-option: BID assigned to IF 01000.
Flow Identifier sub-option: FID 1.
TFT Index Option (1000)
Sub-opt Type (1403): Unique value assigned.
Sub-opt Length (1404): 8 octets.
Path ID (1405): 0001.
Reserved (1406): 0000.
Status (1407): 0000 0000.
Packet Filter Identifier (1408): 0000 0100 0001 0100.
Mobility Binding sub-option: BID assigned to IF 01000.
Flow Identifier sub-option: FID 2.
TFT Index Option (1000)
Sub-opt Type (1403): Unique value assigned.
Sub-opt Length (1404): 8 octets.
Path ID (1405): 0010.
Reserved (1406): 0000.
Status (1407): 0000 0000.
Packet Filter Identifier (1408): 0000 0100 0001 0100.

When P-GW 0104 receives the filter update message 1400, P-GW 0104 will look for the matching TFT described for IF 01000 using the Path ID 1403 and Packet Filter Identifier 1408 for each TFT Index Option 1000 present.
P-GW 0104 would generate the following DSMIP routing filter:
Filtering rules at P-GW 0104
Flow Identifier: FID 1.
Binding Identifier: BID assigned to IF 01000.
Packet filter contents: Source IP address (CN 0110);

Port Number (2300).
Flow Identifier: FID 2.
Binding Identifier: BID assigned to IF 01000.
Packet filter contents: Source IP address (CN 0110);

Port Number (2400).

With the above DSMIP routing filters, P-GW 0104 will route traffic from CN 0110 that matches port number 2300 and 2400 to IF 01000 via the corresponding EPS bearers. Once P-GW 0104 generates the DSMIP routing filters, P-GW 0104 will respond to UE 0100 by indicating the status of the DSMIP routing filter generation with an acknowledgment message. Some examples of the status values that P-GW 0104 could use are:
0: Filtering rule generation successful.
128: Administratively prohibited
136: Filtering rule generation request rejected, reason unspecified
137: TFT Index Option malformed
138: TFT referred does not exist.

The acknowledgment message could be as follows:
Acknowledgement message
BU Packet Header (1401): P-GW 0104 IP address in the source address field;

IF 01001 IP address in the destination address field.
Mobility Binding sub-option: BID assigned to IF 01000.
Flow Identifier sub-option: FID 1.
TFT Index Option (1000)
Sub-opt Type (1403): Unique value assigned.
Sub-opt Length (1404): 8 octets.
Path ID (1405): 0001.
Reserved (1406): 0000.
Status (1407): 0000 0000.
Packet Filter Identifier (1408): 0000 0100 0001 0100.
Mobility Binding sub-option: BID assigned to IF 01000.
Flow Identifier sub-option: FID 2.
TFT Index Option (1000)
Sub-opt Type (1403): Unique value assigned.
Sub-opt Length (1404): 8 octets.
Path ID (1405): 0010.
Reserved (1406): 0000.
Status (1407): 0000 0000.
Packet Filter Identifier (1408): 0000 0100 0001 0100.

### Embodiment 13

### UE Decision to Set Routing Filter Based on TFT Using Reference Pointer Variant

In yet another preferred embodiment, the filter update message that UE sends when triggered by the decision of TFT could contain a routing filter description as described in Non-Patent Document 4 along with a TFT Index Option 1000. The message format for this filter update message could be similar to the format shown in FIG. 14 and details on the format is already described in the previous embodiment. In addition, as a form of optimization of the packet size, the UE can use a bit in the Reserved field 1406 to indicate to P-GW to use all TFTs specified on the 3GPP access interface to generate the DSMIP routing filters. For example, UE 0100 can send a filter update message 1400 with the Path ID 1405 and Packet Filter Identifier 1408 omitted and with a bit in the Reserved field 1406 set to let P-GW 0104 know that UE 0100 wants to request P-GW 0104 to use all TFTs defined for IF 01000 to generate the corresponding DSMIP routing filters.

### Embodiment 14

### UE Decision to Set Routing Filter Based on TFT Using Existing Packet Filter Description

In another preferred embodiment, the filter update message that UE sends when triggered by the decision of TFT could contain a normal routing filter description as described in Non-Patent Document 4. When the UE has the TFT on 3G interface, it refers the packet filter that is included in the TFT to make the routing filter description. There are various reasons why the UE may want to do it. One reason could be that the P-GW does not implement the functionality to identify a packet filter that is included in a TFT of the 3GPP bearer by using a packet filter identifier and hence does not know how to generate the corresponding DSMIP routing filters based on TFTs. The UE could know that the P-GW does not implement this functionality if the acknowledgment from the P-GW does not contain any TFT Index Option when the filter update message sent by the UE contains one or more TFT Index Options.

The following is an example that describes the above in greater detail. Assuming that UE 0100 receive from P-GW 0104 the following TFTs for IF 01000:
EPS Bearer Identity: 0001
Packet filter identifier: 0000 0100 0001 0100.
Packet filter contents: Source IP address (CN 0110);

Port Number (2300).
EPS Bearer Identity: 0010
Packet filter identifier: 0000 0100 0001 0100.
Packet filter contents: Source IP address (CN 0110);

Port Number (2400).

With the reception of the TFTs by UE 0100, UE 0100 decision process is triggered to evaluate if the corresponding DSMIP routing filters need to be set at P-GW 0104. Once UE 0100 determines that DSMIP routing filters need to be set at P-GW 0104, UE 0100 sends the filter update message 1400 to P-GW 0104. However, P-GW 0104 does not implement this invention and hence the acknowledgement message from P-GW 0104 would not contain any TFT Index Option. From the acknowledgement message, UE 0100 can derive that P-GW 0104 does not understand this invention and thus, UE 0100 sends the filter update message as follows:
Filter Update Message (1400)
BU Packet Header (1401): IF 01000 IP address in the source address field;

P-GW 0104 IP address in the destination address field.
Mobility Binding sub-option: BID assigned to IF 01000.
Flow Identifier sub-option: FID 1;

Source IP address (CN 0110);

Destination IP address (IF 01000);

Port Number (2300 to 2400).

UE may know that P-GW 104 does not know how to handle TFT Index Option by other means as well. For example, the UE may cache this knowledge from a first attempt to set a routing filter using TFT Index Option. After this first attempt, the UE will decide to use TFT Index Option or use normal routing filter description based on the cached knowledge. As another example, the UE may know this through the software or release version number of the P-GW. As yet another example, the UE may know this through some information service provided by the network. As a further example, the UE may be configured not to send TFT Index Option through dynamic (e.g. Over-the-Air update) or static (SIM card parameters) means.

As a variation in this preferred embodiment, there is the way to improve the size of the routing filter description set by the UE by reducing the functionality which the P-GW 104 needs to implement. In this variation, the P-GW 104 has only the functionality to identify the packet filter by using the information provided by the filter update message on behalf of the full functionality to process the TFT Index Option. In this case, the UE checks the packet filters in the TFT and selects the element which allows the P-GW to uniquely identify a packet filter in the TFT to make the routing filters. The selected element can be one or more than one elements. After that, the UE contains the selected element in the filter update message and sends it to the P-GW. When the P-GW receives the filter update message, it identifies a packet filter by using the information contained as the routing filter description. For example, if the Port Number (2400) is only contained as the routing filter description in the filter update message, the P-GW 0104 will look for the matching TFT which contains the Port Number (2400). As a result of that, the P-GW 0104 will identify the packet filter for EPS Bearer Identity: 0010. The benefit for this is that the filter update message size is reduced since the message does not need to contain the whole routing filter description and the P-GW does not need to implement the functionality to process the TFT Index Option.

### Embodiment 15

### UE Decision to Set Routing Filter Based on TFT for Policy Conflict

In yet another preferred embodiment, UE may decide to use TFT to generate routing filters if the multiple traffic flow policies received by the UE contradict each other. This embodiment also uses FIG. 11 to explain UE. A reason why flow policies can conflict is the fact that there are multiple network entities providing the flow policy to the UE. One example is that the traffic flow policies are sent to the UE either via the 3GPP access or the non-3GPP access by a network entity known as Access Discovery and Selection Function (ANDSF) of different operators. The traffic flow policies allow operators to specify how a particular traffic flow is to be routed. Typically, when a UE is roaming, it is possible for the UE to get a traffic flow policy from the UE's home operator and a traffic flow policy from the UE's visited operator. FIG. 17 depicts a flow chart on how the decision is taken by a UE for notifying P-GW of routing filter according to one preferred embodiment of this invention. The following description is about the processing of decision taken by the UE depicted in FIG. 11. If the path setup decision engine 1104 detects that there is the policy for a same flow in both the home operator's policy and the visited operator's policy in the filter database module 1103 (1700), and both policies are in conflict with each other (S17011), the path setup decision engine 1104 can make use of how similar flows are being routed over the 3GPP access bearers to know how to set the DSMIP routing filter at the P-GW. In the event of policies conflict, i.e. one policy says flow goes to 3GPP access while another says flow goes to non-3GPP access, the path setup decision engine 1104 can use the TFT to know which policy is the correct one. Hence, UE uses the TFT to determine the correct routing rule to set. For example, when the path setup decision engine 1104 refers the filter database module 1103 and finds a TFT for 3GPP access with packet filter that indicates the same traffic (1702, S17021), the path setup decision engine 1104 decides to register the routing rule which indicates that the flow is to be routed to 3GPP access (1704). Then the path setup decision engine 1104 sends the information contained in the packet filter/TFT to the filter generation engine 1101 and requests to make the routing rule. The filter generation engine 1101 uses the information in the packet filter/TFT (such as an identifier of the packet filter in the TFT, or an identifier of the entire TFT as a whole) to make the routing rule to indicate that the flow should be routed over the 3GPP access then send the routing rule to correct this (1705, 1706). If the filter generation engine 1101 uses the identifier of the packet filter, the routing rule that corresponds to the packet filter identified by the identifier is requested to be created. While, the filter generation engine 1101 uses the identifier of the entire TFT to make the routing rule (1705), then the routing rules that correspond to all packet filters included in the TFT identified by the identifier are requested to be created. The identifier of the entire TFT can be the EPS bearer ID to which the TFT is associated. The message includes the information to identify the TFT and information to indicate the access system (3GPP access) to be used to receive the packet flow. The message can be sent over either 3GPP or non-3GPP. If the TFT which contains the packet filter corresponding to the flow is not present in step 1702 (S17020), the path setup decision engine 1104 decides to register the routing rule which indicates that the flow is to be routed to non-3GPP access (1703).

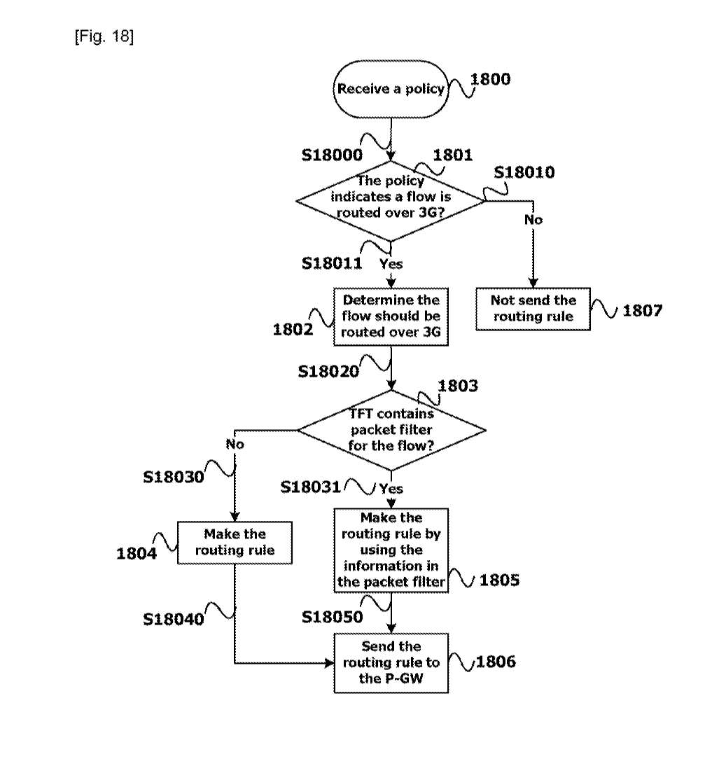

In another example, the traffic flow policies are sent by multiple ANDSFs belonging to the same operator. The UE can use the same methodology described in this embodiment to resolve the policy conflicts between different ANDSFs. Yet another example, the policy for routing rule (traffic flow policy) or the policy for selecting bearer (TFT/packet filter) in 3GPP access are sent by different network entities belonging to the same operator. For example, one set of traffic flow policy is sent by the ANDSF while another set of packet filters are sent by the Policy Control and Charging Function (PCRF) through the PDN GW using traffic flow templates (TFTs). The lack of interface between the ANDSF and PCRF or PDN GW can imply that no communication between them when flow policy is configured. Thus, as depicted in FIG. 18, when the path status processing engine 1105 receives flow policy from the ANDSF (1800) which indicates that the flow should be routed over the 3GPP access (1801), it stores it in filter database module 1103 and notifies it to the path setup decision engine 1104. Then based on the policy, the path setup decision engine 1104 determines that the flow should be routed over 3GPP access (1802), then refers the filter database module 1103 and checks if the TFT which contains the packet filter corresponding to the flow in the flow policy is present (1803). If it is present (S18031), the path setup decision engine 1104 sends the information contained in the packet filter/TFT to the filter generation engine 1101 and requests to make the routing rule. The filter generation engine 1101 uses the information in the packet filter/TFT (such as an identifier of the packet filter in the TFT, or an identifier of the entire TFT as a whole) to make the routing rule to indicate that the flow should be routed over the 3GPP access then send the routing rule to correct this (1805,1806). If the filter generation engine 1101 uses the identifier of the packet filter, the routing rule that corresponds to the packet filter identified by the identifier is requested to be created. While, the filter generation engine 1101 uses the identifier of the entire TFT to make the routing rule (1805), then the routing rules that correspond to all packet filters included in the TFT identified by the identifier are requested to be created. The identifier of the entire TFT can be the EPS bearer ID to which the TFT is associated. The message includes the information to identify the TFT and information to indicate the access system (3GPP access) to be used to receive the packet flow. The message can be sent over either 3GPP or non-3GPP. If the TFT which contains the packet filter corresponding to the flow is not present in step 1803 (S18030), the path setup decision engine 1104 requests the filter generation engine 1101 to make the routing rule. In this case, the path setup decision engine 1104 makes the routing rule only based on the information in the flow policy. The reception of traffic flow policy can be, but not limited to, reception of a new traffic flow policy or an update to an existing traffic flow policy (1804).

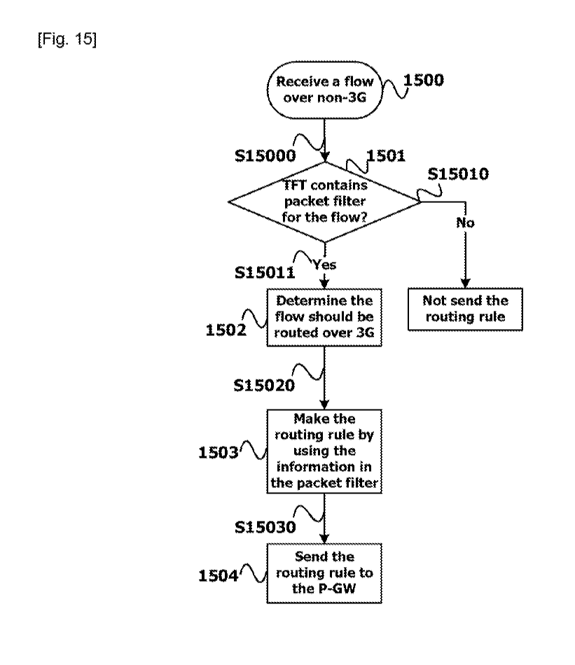

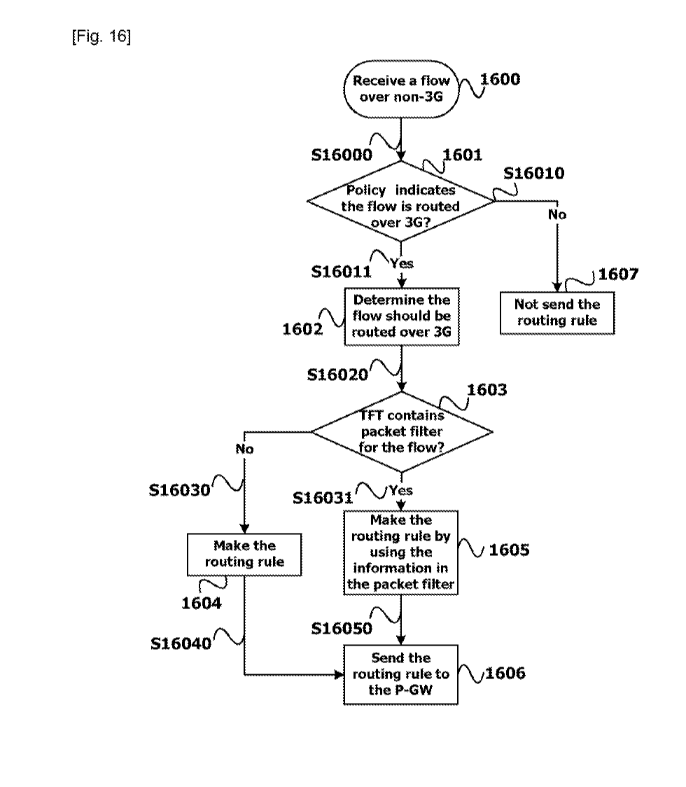

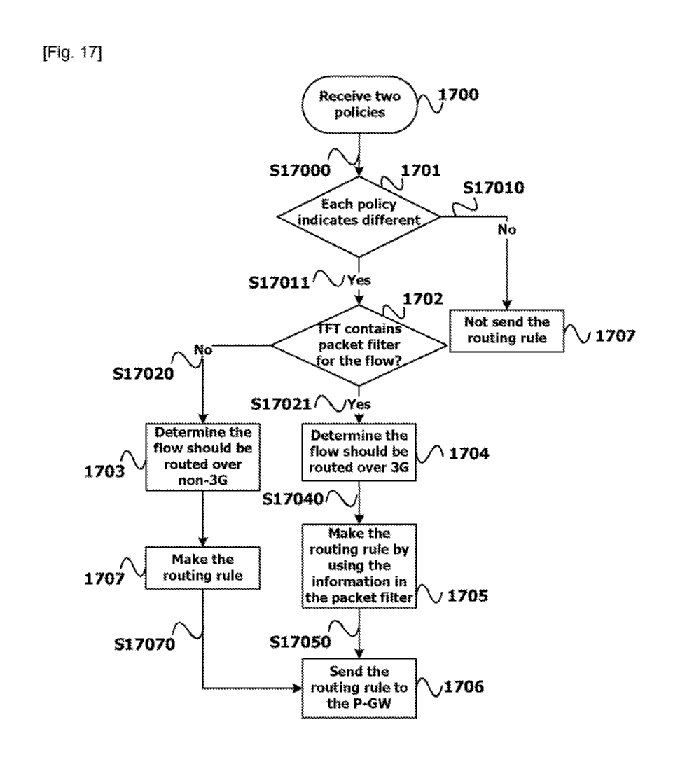

The above embodiments cover the case where the UE makes the decision to set routing filters based on triggers from application needs or ANDSF policies. Another trigger may be from the case where a packet is delivered not according to the current configuration of routing filters and/or TFTs. This is called a mis-match. For example, the UE may, under the hint from an application (say, App1), request a TFT to be associated with a 3GPP bearer. After some time, the path status processing engine 1105 noticed that packets for App1 are still delivered using the non-3GPP access. This mis-match in routing filters/TFTs and packet delivery may trigger the UE to set up additional routing filters. In this particular example, the mis-match may be caused by a general routing filter being installed by the filter generation engine 1101 using DSMIP BU messages that route all packets from a specific CN to the non-3GPP access, and App1 (the applications 1102) happens to be communicating with this specific CN. The assumption is that the UE has a flow to be routed over 3GPP access, hence the appropriate TFT has been set by the network. When the non-3GPP access becomes the default route, UE has to set the correct routing filter to ensure flow goes to 3GPP access. Because routing filters are evaluated before 3GPP TFTs, packets for App1 will be routed to non-3GPP access and the 3GPP TFT has no chance of being evaluated. FIG. 15 depicts a flow chart on how the decision is taken by a UE for notifying P-GW of routing filter according to one preferred embodiment of this invention. The following description is about the processing of decision taken by the UE depicted in FIG. 11. When the network interface module 110 receives the flow over the non-3GPP access (1500), it notifies (S15000) the flow to the path setup decision engine 1104. Then the path setup decision engine 1104 refers the filter database module 1103 and checks if TFT contains the packet filter which corresponds to the flows (1501). If the TFT which contains the packet filter corresponding to the flow is present (S15011), the path setup decision engine 1104 determines that the flow should be routed over 3GPP access, then the path setup decision engine 1104 sends the information contained in the packet filter/TFT to the filter generation engine 1101 and requests to make the routing rule. The filter generation engine 1101 uses the information in the packet filter/TFT (such as an identifier of the packet filter in the TFT, or an identifier of the entire TFT as a whole) to make the routing rule to indicate that the flow should be routed over the 3GPP access then send the routing rule to correct this (1503,1504). If the filter generation engine 1101 uses the identifier of the packet filter, the routing rule that corresponds to the packet filter identified by the identifier is requested to be created. While, the filter generation engine 1101 uses the identifier of the entire TFT to make the routing rule (1503), then the routing rules that correspond to all packet filters included in the TFT identified by the identifier are requested to be created. The identifier of the entire TFT can be the EPS bearer ID to which the TFT is associated. The message includes the information to identify the TFT and information to indicate the access system (3GPP access) to be used to receive the packet flow. The message can be sent over either 3GPP or non-3GPP. Additionally, as depicted in FIG. 16, when the path setup decision engine 1104 receives the flow over the non-3GPP access (1600), it can also first refer the filter database module 1103 and check if there is a policy for routing rule from ANDSF (or other policy providing entity) which indicates that the flow should be routed over the 3GPP access (1601). If the policy which indicates that the flow should be routed over the 3GPP access is present (S16011), the path setup decision engine 1104 determines that the flow should be routed over 3GPP access (1602), then the path setup decision engine 1104 refers the filter database module 1103 again and checks if TFT contains the packet filter which corresponds to the flows (1603). If the packet filter is present (S16031), the path setup decision engine 1104 sends the information contained in the packet filter/TFT to the filter generation engine 1101 and requests to make the routing rule. The filter generation engine 1101 uses the information in the packet filter/TFT (such as an identifier of the packet filter in the TFT, or an identifier of the entire TFT as a whole) to make the routing rule to indicate that the flow should be routed over the 3GPP access then send the routing rule to correct this (1605,1606). If the filter generation engine 1101 uses the identifier of the packet filter, the routing rule that corresponds to the packet filter identified by the identifier is requested to be created. While, the filter generation engine 1101 uses the identifier of the entire TFT to make the routing rule (1605), then the routing rules that correspond to all packet filters included in the TFT identified by the identifier are requested to be created. The identifier of the entire TFT can be the EPS bearer ID to which the TFT is associated. The message includes the information to identify the TFT and information to indicate the access system (3GPP access) to be used to receive the packet flow. The message can be sent over either 3GPP or non-3GPP. If the TFT which contains the packet filter corresponding to the flow is not present in step 1603 (S16030), the path setup decision engine 1104 requests the filter generation engine 1101 to make the routing rule. In this case, the path setup decision engine 1104 makes the routing rule only based on the information in the flow policy (1604).

Previous preferred embodiments of the present invention have disclosed several ways for the UE to correct the situation. One way is to include a TFT Index Option in a DSMIP BU message, wherein the said TFT Index Option refers to the TFT associated with the 3GPP Bearer for App1. This will cause the P-GW to install a routing filter generated from the 3GPP TFT, thus resolving the mis-match. Another way is for the UE to generate a DSMIP routing filter description from the TFT associated with the 3GPP bearer for App1, and insert this filter description into a DSMIP BU message. This will cause the P-GW to install a routing filter generated from the 3GPP TFT, thus resolving the mis-match. Yet another way is for the UE to send an EPS Bearer Modification message to the MME to modify the TFT associated with the 3GPP Bearer for App1. In this EPS Bearer Modification message, the UE inserts an indication to request the P-GW to generate a routing filter from the TFT associated with this EPS Bearer. The MME will proceed to pass this indication to the S-GW in a Bearer Resource Command message. In turn, the S-GW will pass this indication to the P-GW in a Bearer Resource Command message. This will cause the P-GW to install a routing filter generated from the 3GPP TFT, thus resolving the mis-match.

One specific way, as an example illustration, is the case if for the UE, when attaching to both a 3GPP access and non-3GPP access to send a binding update to perform a simultaneously at home and away binding and to install routing filters corresponding to the TFTs to ensure that flows which are eligible for QoS treatment be routed to the 3GPP access. For example, in such simultaneous attachment, if there is only a single TFT tied to EPS bearer 1 which maps packet filter 1 to EPS bearer 1, the UE may send a bulk binding update (BU) to ensure that flows tied to packet filter 1 are sent via the 3GPP access. This bulk BU will have TFT reference in the TFT Index Option (can also be called a TFT Reference Traffic Selector sub-option). The packet structure of such BU will contain IPv6 header and a BU mobility header. Attached to the BU mobility header will be Binding Identifier (BID1) mobility option (BID for non-3GPP access) where BID1 priority is set to a low value (implying high priority). Following BID1, a BID2 (BID for 3GPP access) and Flow Identifier (FID1) mobility option tied to BID2 will be attached. FID1 carries the reference to TFT1 (which is the EPS bearer 1) in the TFT Reference Traffic Selector sub-option. Once the P-GW receives and successfully processes such binding update message with TFT Reference Traffic Selector sub-option, it will install the corresponding simultaneous at home and away registration. The P-GW will also locate the packet filters in the TFTs referred to by the TFT Reference Traffic Selector sub-option and install relevant routing rules based on a one-to-one conversion from each located Packet Filter. The TFT Reference Traffic Selector sub-option may preferably contain the following field: a Sub-Opt Type filed to indicate this is a Traffic Selector option; a Sub-Opt Length field which is an 8-bit unsigned integer, representing the length in octets of the TFT Reference Traffic Selector Sub-option—this field indicates the length of the sub-option not including the Sub-opt Type and Sub-opt Length fields; the TS Format field which is an 8-bit unsigned integer indicating the Traffic Selector Format; a Reserved field which is an 8-bit reserved field” it should be set to zero by the sender and ignored by the receiver; and a TFT Reference field which is an 8 bit field used to carry the EPS bearer ID.

Once the P-GW generates the routing filter from the TFT referred by the TFT Reference Traffic Selector sub-option, one implementation may allow the P-GW to install a hook to link the TFT to the routing rules so that any changes to the TFT can trigger an immediate re-generation of the routing rules by the P-GW without needing to receive a separate BU. This eliminates the need for the UE to send a BU message to re-generate the routing rules every time a TFT is modified. It is preferable that, when the P-GW has the capability to automatically re-generate the routing rules, the P-GW shall inform the UE so that the UE knows that it does not need to send a BU when a previously referred TFT is modified. This can be done in many ways, such as using a flag or an option in the Binding Acknowledgement sent by the P-GW to indicate to the UE whether the P-GW has the capability to automatically re-generate the routing filter when TFT is modified.

Also, this invention introduces the path status generating engine 1204 where the objective is to notify the status for a particular request for a new QoS path or a request for P-GW to self-generate TFT. An example is that the path status generating engine 1204 creates the path notification message 070 which may include the self-generated TFTs from the TFT generation engine 1203. The signal/data path S12006 allows packets (e.g. path notification message 070) to be sent to the network interface module 1200 for transmission.

Although the invention has been herein shown and described in what is conceived to be the most practical and preferred embodiment, it will be appreciated by those skilled in the art that various modifications may be made in details of design and parameters without departing from the scope and ambit of the invention. For instance, the filter update message (050) described in this invention could contain, in any permutation, a single or plurality of Filter Option (052), a single or plurality of QoS Option (053) and a single or plurality of TFT Option (054).

This invention also provides an apparatus for notifying intention for dynamic path setup comprising:
a decision unit that determines the requirement for a new communication path to be setup;
an informing unit that notifies the intention of dynamically configuring a new communication path; and
a reception unit that receives the indication that the new communication path has been setup as requested.

Furthermore, the above apparatus can comprise a generation unit that dynamically maps one set of filtering rules (i.e. routing filters or packet filters) for one communication path to other communication path.

Furthermore, in the above apparatus, it is possible that said set of filtering rules (i.e. routing filters or packet filters) is a Traffic Flow Template associated with a cellular-based communication path, and notification of mapping the said filtering rules is sent via a non-cellular-based access.

Furthermore, in the above apparatus, it is possible that the decision unit comprises:

(i) a first determination unit that determines if a new QoS path is required on the new communication path; and

(ii) a second determining unit that determines if a network-generated TFT is required for the new QoS path.

Furthermore, in the above apparatus, it is possible that the informing unit comprises:

(i) a first notification unit that notifies if a new QoS path is required on the new communication path; and
(ii) a second notification unit that notifies if a network-generated TFT is required for the new QoS path.

Furthermore, in the above apparatus, it is possible that said first and second notification units transmit the notification in a message to be sent via a cellular-based access.

This invention also provides a method used by the above apparatus, comprising the steps of:

sending a filter update message to notify a network element of the matching of data packet to a set of packet description and how to route matched data packet, characterized in that said filter update message contains a reference to an existing set of packet description installed elsewhere in the network element instead of the actual set of packet description; and

sending of the filter update message to the network element via a non-cellular-based access.

Furthermore, the above method can comprise a step of adding a QoS indication into the filter update message, such that said QoS indication indicates to the network element whether a new QoS path needs to be established for data packets that matches the set of packet description referenced in this filter update message.

Furthermore, the above method can comprise a step of adding an immediate indication into the filter update message, such that said immediate indication indicates to the network element whether the said new QoS path needs to be established immediately upon reception of the filter update message.

Furthermore, the above method can comprise a step of sending the filter update message to the network element via a cellular-based access.

Each functional block used in the description of the embodiments as given above can be realized as LSI, typically represented by the integrated circuit. These may be produced as one chip individually or may be designed as one chip to include a part or all. Here, it is referred as LSI, while it may be called IC, system LSI, super LSI, or ultra LSI, depending on the degree of integration. Also, the technique of integrated circuit is not limited only to LSI and it may be realized as a dedicated circuit or a general-purpose processor. FPGA (Field Programmable Gate Array), which can be programmed after the manufacture of LSI, or a reconfigurable processor, in which connection or setting of circuit cell inside LSI can be reconfigured, may be used. Further, with the progress of semiconductor technique or other techniques derived from it, when the technique of circuit integration to replace LSI may emerge, the functional blocks may be integrated by using such technique. For example, the adaptation of bio-technology is one of such possibilities.

### INDUSTRIAL APPLICABILITY

This invention has the advantage of dynamically configuring a new communication path, saving the battery power and reducing a number of message exchanges and delay, and can be applied to the field of telecommunications in a packet-switched data communications network system.

1-8. (canceled)

9. A user equipment device having a first interface for connecting to a network via a first access system and a second interface for connecting the network via a second access system, and the user equipment device for controlling an interface to receive a packet flow transmitted from a predetermined node in the network, the user equipment device comprising:
a packet filter identifier acquiring unit configured to acquire an identifier of a packet filter from the packet filter set at the user equipment device, the packet filter used to select an appropriate bearer to receive a packet flow on the first interface via the first access system;
a determining unit configured to determine an interface to receive a packet flow transmitted from the predetermined node in the network; and
a transmitting unit configured to transmit a message from either the first or second interface to the predetermined node in the network, the message including the identifier of the packet filter and information to indicate an access system corresponding to the determined interface.

10. The user equipment device according to claim 8, further comprising:
a notifying unit configured to notify that a packet filter is set at the user equipment device, and wherein, when being notified from the notifying unit that a packet filter is newly set, the determining unit determines that a packet flow including information contained in the packet filter should be received on the first interface via the first access system.

11. The user equipment device according to claim 8, further comprising:
a packet filter confirming unit configured to, when receiving a packet flow on the second interface, confirm whether a packet filter containing information included in the received packet flow is set at the user equipment device, and
wherein, when the packet filter confirming unit confirms that the packet filter containing information included in the received packet flow is set at the user equipment device, the determining unit determines that the received packet flow should be received on the first interface via the first access system.

12. The user equipment device according to claim 8, further comprising:
a packet filter confirming unit configured to, when receiving a packet flow on the second interface, confirm whether a packet filter containing information included in the received packet flow is set at the user equipment device;
a policy confirming unit configured to confirm whether a policy is set at the user equipment device, the policy indicating an access system via which the packet flow received on the second interface should be received; and
a transmission controlling unit configured to control whether the transmitting unit transmits the message,
wherein, when the policy confirming unit confirms that the policy indicating that the packet flow received on the second interface should be received on the first interface via the first access system is set at the user equipment device, the determining unit determines that the packet flow received on the second interface should be received on the first interface via the first access system, and
wherein, when the packet filter confirming unit confirms that the packet filter containing information included in the packet flow received on the second interface is set at the user equipment device, the transmission controlling unit controls the transmitting unit to send the message.

13. The user equipment device according to claim 8 further comprising:
a policy receiving unit configured to receive a policy indicating an access system via which a packet flow from the predetermined node should be received, the policy including information to identify the packet flow; and
a packet filter confirming unit configured to acquire the information to identify the packet flow from the policy receiving unit, and confirm whether a packet filter containing the acquired information to identify the packet flow is set at the user equipment device;
wherein, when receiving the policy indicating that the packet flow transmitted from the predetermined node in the network should be received on the first interface via the first access system, the policy receiving unit notifies the packet filter confirming unit of the information to identify the packet flow, and
wherein, when the packet filter confirming unit confirms that the packet filter including the information to identify the packet flow is set at the user equipment device, the determining unit determines that the packet flow should be received on the first interface via the first access system.

14. The user equipment device according to claim 12,
wherein, when the policy receiving unit receives a policy indicating that the packet flow transmitted from the predetermined node in the network should be received on the second interface via the second access system, the determining unit determines that the packet flow should be received on the second interface via the second access system.

15. The user equipment device according to claim 13,
wherein when the policy receiving unit receives, from a first network entity in the network, a policy indicating that the packet flow transmitted to a predetermined node in the network should be received on the first interface via the first access system, and receives, from a second network entity in the network, a policy indicating that the packet flow should be received on the second interface via the second access system, the policy receiving unit notifies the packet filter confirming unit of information to identify the packet flow, and
wherein when the packet filter confirming unit confirms that a packet filter including the information to identify the packet flow is set at the user equipment device, the determining unit determines that the packet flow should be received on the first interface via the first access system.

16. The user equipment device according to claim 8, wherein the first access system is 3GPP access network and the second access system is non-3GPP access network.
